(19) United States
(12) Patent Application Publication
(10) Pub. No.: US 2025/0245567 A1
(43) Pub. Date: Jul. 31, 2025

(54) EFFICIENT POST-TRAINING VECTOR QUANTIZATION FOR DEEP NEURAL NETWORK WEIGHTS

(71) Applicant: QUALCOMM Incorporated, San Diego, CA (US)

(72) Inventors: Andrey KUZMIN, Amsterdam (NL); Marinus Willem VAN BAALEN, Amsterdam (NL); Paul Nicholas WHATMOUGH, Cambridge, MA (US); Markus NAGEL, Amsterdam (NL); Tijmen Pieter Frederik BLANKEVOORT, Amsterdam (NL)

(21) Appl. No.: 18/923,505

(22) Filed: Oct. 22, 2024

Related U.S. Application Data
(60) Provisional application No. 63/627,729, filed on Jan. 31, 2024.

(51) Int. Cl. G06N 20/00

(52) U.S. Cl. CPC G06N 20/00

(57) ABSTRACT

Systems and techniques are described for quantizing parameters (e.g., post-training vectors) associated with a pre-trained model. For example, a device can obtain a codebook for a group of weights of a pre-trained machine learning model. The device can determine a compression ratio based on the codebook and at least one of a vector quantization dimensionality, a group size, a codebook bit-width, or a scale group size. The device can quantize, via a vector quantization engine, the group of weights of the pre-trained machine learning model a plurality of columns at a time according to the compression ratio to generate a quantized pre-trained model.

### PRIORITY CLAIM

The present application claims priority to U.S. Provisional App. No. 63/627,729, filed on Jan. 31, 2024, the contents of which are incorporated herein by reference.

### TECHNICAL FIELD

The present disclosure generally relates to deep learning neural networks. For example, aspects of the present disclosure relate to quantizing parameters (e.g., post-training vectors) associated with a pre-trained model.

### BACKGROUND

Machine learning models (e.g., deep neural networks, such as large language models (LLMs), convolutional neural networks, transformers, diffusion models, etc.) are trained to provide an inference or prediction based on input data. For example, deep neural networks (e.g., LLMs, etc.) can be pre-trained on large datasets to generalize to a wide range of tasks. Applications of deep neural networks include text summarization, text generation, sentiment analysis, content creation such as performing generative operations, chatbots, virtual assistants, and conversational artificial intelligence, named entity recognition, speech recognition and synthesis, image annotation, text-to-speech synthesis, spell correction, machine translation, recommendation systems, fraud detection, accomplishing tasks and code generation.

However, generation of machine learning models is expensive to execute. The large expense can be based on a large number of parameters included in machine learning models, including deep neural networks. For instance, LLMs have a large number (e.g., billions) of parameters that need to be moved back and forth between memory for execution. One primary bottleneck for efficient LLM inference are weights. The cost of movement of parameters (e.g., weights) to and from memory is generally greater than the cost of calculation.

### SUMMARY

Systems and techniques are described herein for quantizing parameters (e.g., post-training vectors) associated with a pre-trained model. In some aspects, an apparatus for quantizing one or more machine learning models is provided. The apparatus includes at least one memory and at least one processor coupled to the at least one memory and configured to: obtain a codebook for a group of weights of a pre-trained machine learning model; determine a compression ratio based on the codebook and at least one of a vector quantization dimensionality, a group size, a codebook bit-width, or a scale group size; and quantize, via a vector quantization engine, the group of weights of the pre-trained machine learning model a plurality of columns at a time according to the compression ratio to generate a quantized pre-trained model.

In some aspects, a method for quantizing one or more machine learning models is provided. The method includes: obtaining a codebook for a group of weights of a pre-trained machine learning model; determining a compression ratio based on the codebook and at least one of a vector quantization dimensionality, a group size, a codebook bit-width, or a scale group size; and quantizing, via a vector quantization engine, the group of weights of the pre-trained machine learning model a plurality of columns at a time according to the compression ratio to generate a quantized pre-trained model.

In some aspects, an apparatus for quantizing one or more machine learning models is provided. The apparatus includes: means for obtaining a codebook for a group of weights of a pre-trained machine learning model; means for determining a compression ratio based on the codebook and at least one of a vector quantization dimensionality, a group size, a codebook bit-width, or a scale group size; and means for quantizing, via a vector quantization engine, the group of weights of the pre-trained machine learning model a plurality of columns at a time according to the compression ratio to generate a quantized pre-trained model.

In some aspects, a non-transitory computer-readable medium is provided having stored thereon instructions that, when executed by one or more processors, cause the one or more processors to: obtain a codebook for a group of weights of a pre-trained machine learning model; determine a compression ratio based on the codebook and at least one of a vector quantization dimensionality, a group size, a codebook bit-width, or a scale group size; and quantize, via a vector quantization engine, the group of weights of the pre-trained machine learning model a plurality of columns at a time according to the compression ratio to generate a quantized pre-trained model.

In some aspects, an apparatus for quantizing one or more machine learning models is provided. The apparatus includes at least one memory and at least one processor coupled to the at least one memory and configured to: arrange, via a quantization engine, data associated with a pre-trained model into a plurality of groups; scale down data in each group of the plurality of groups to obtain first scaled data in the plurality of groups; assign a respective codebook to a respective group of the plurality of groups; and for a set of columns of data of a respective group of the plurality of groups obtained by a vector quantization dimensionality: scale up data in the set of columns to generate second scaled data of the set of columns; quantize, via the quantization engine, the second scaled data of the set of columns; identify an error associated with quantizing the second scaled data of the set of columns; and update, based on the error, data in remaining columns of the plurality of groups.

In some aspects, a method for compressing a pre-trained model is provided. The method including: arranging, via a quantization engine, data associated with a pre-trained model into a plurality of groups; scaling down data in each group of the plurality of groups to obtain first scaled data in the plurality of groups; assigning a respective codebook to a respective group of the plurality of groups; and for a set of columns of data of a respective group of the plurality of groups obtained by a vector quantization dimensionality: scaling up data in the set of columns to generate second scaled data of the set of columns; quantizing, via the quantization engine, the second scaled data of the set of columns; identifying an error associated with quantizing the second scaled data of the set of columns; and updating, based on the error, data in remaining columns of the plurality of groups.

In some aspects, an apparatus for compressing a pre-trained model is provided. The apparatus includes: means for arranging, via a quantization engine, data associated with a pre-trained model into a plurality of groups; means for scaling down data in each group of the plurality of groups to obtain first scaled data in the plurality of groups; means for assigning a respective codebook to a respective group of the plurality of groups; and means for, for a set of columns of data of a respective group of the plurality of groups obtained by a vector quantization dimensionality: scaling up data in the set of columns to generate second scaled data of the set of columns; quantizing, via the quantization engine, the second scaled data of the set of columns; identifying an error associated with quantizing the second scaled data of the set of columns; and updating, based on the error, data in remaining columns of the plurality of groups.

In some aspects, a non-transitory computer-readable medium is provided having stored thereon instructions that, when executed by one or more processors, cause the one or more processors to: arrange, via a quantization engine, data associated with a pre-trained model into a plurality of groups; scale down data in each group of the plurality of groups to obtain first scaled data in the plurality of groups; assign a respective codebook to a respective group of the plurality of groups; and for a set of columns of data of a respective group of the plurality of groups obtained by a vector quantization dimensionality: scale up data in the set of columns to generate second scaled data of the set of columns; quantize, via the quantization engine, the second scaled data of the set of columns; identify an error associated with quantizing the second scaled data of the set of columns; and update, based on the error, data in remaining columns of the plurality of groups.

In some aspects, an apparatus for compressing a pre-trained model is provided. The apparatus includes at least one memory and at least one processor coupled to the at least one memory and configured to: receive, at a vector quantization engine, the pre-trained model; scale data from a plurality of columns in a group of a plurality of groups, the data being associated with the pre-trained model to yield scaled data in the plurality of columns; assign a codebook to the scaled data in the plurality of columns; inverse scale the scaled data in the plurality of columns to obtain inverse scaled data; quantize the inverse scaled data to obtain quantized data; generate an error based on the quantized data; update, based on the error, weights in the plurality of columns to obtain updated weights in the plurality of columns; and update weights, based on the error, in remaining columns in remaining groups from the plurality of groups.

In some aspects, an apparatus for compressing a pre-trained model is provided. The apparatus includes at least one memory and at least one processor coupled to the at least one memory and configured to: receive, at a vector quantization engine, the pre-trained model; scale data from a plurality of columns in a group of a plurality of groups, the data being associated with the pre-trained model to yield scaled data in the plurality of columns; assign a codebook to the scaled data in the plurality of columns; inverse scale the scaled data in the plurality of columns to obtain inverse scaled data; quantize the inverse scaled data to obtain quantized data; generate an error based on the quantized data; update, based on the error, weights in the plurality of columns to obtain updated weights in the plurality of columns; and update weights, based on the error, in remaining columns in remaining groups from the plurality of groups.

In some aspects, a method for compressing a pre-trained model is provided. The method includes: receiving, at a vector quantization engine, the pre-trained model; scaling data from a plurality of columns in a group of a plurality of groups, the data being associated with the pre-trained model to yield scaled data in the plurality of columns; assigning a codebook to the scaled data in the plurality of columns; inverse scaling the scaled data in the plurality of columns to obtain inverse scaled data; quantizing the inverse scaled data to obtain quantized data; generating an error based on the quantized data; updating, based on the error, weights in the plurality of columns to obtain updated weights in the plurality of columns; and updating weights, based on the error, in remaining columns in remaining groups from the plurality of groups.

In some aspects, non-transitory computer-readable medium is provided having stored thereon instructions that, when executed by one or more processors, cause the one or more processors to: receive, at a vector quantization engine, the pre-trained model; scale data from a plurality of columns in a group of a plurality of groups, the data being associated with the pre-trained model to yield scaled data in the plurality of columns; assign a codebook to the scaled data in the plurality of columns; inverse scale the scaled data in the plurality of columns to obtain inverse scaled data; quantize the inverse scaled data to obtain quantized data; generate an error based on the quantized data; update, based on the error, weights in the plurality of columns to obtain updated weights in the plurality of columns; and update weights, based on the error, in remaining columns in remaining groups from the plurality of groups.

In some aspects, one or more of apparatuses described herein include a mobile device (e.g., a mobile telephone or so-called “smart phone” or other mobile device), a wireless communication device, a vehicle or a computing device, system, or component of the vehicle or an autonomous driving vehicle, an extended reality device (e.g., a virtual reality (VR) device, an augmented reality (AR) device, an extended reality (XR) or a mixed reality (MR) device), a wearable device, a personal computer, a laptop computer, a server computer, a camera, or other device, devices used for image/video editing and image/video generation and editing. In some aspects, the one or more processors include an image signal processor (ISP). In some aspects, the apparatus includes a camera or multiple cameras for capturing one or more images. In some aspects, the one or more apparatuses include an image sensor that captures the image data. In some aspects, one or more apparatuses include a display for displaying the image, one or more notifications (e.g., associated with processing of the image), and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating weight transfer overhead at inference time for a large language model, in accordance with some aspects of this disclosure;

FIG. 2 is a diagram illustrating the use of clusters of data and centroids, in accordance with some aspects of this disclosure;

FIG. 3 is a diagram illustrating the use of clusters of data with centroids and the use of reshaped weight tensors and codebooks, in accordance with some aspects of this disclosure;

FIG. 4 illustrates an example generative pre-trained transformer quantization, in accordance with some aspects of this disclosure;

FIG. 5A illustrates a block diagram illustrating an example of a system including a vector quantization engine, in accordance with some aspects of this disclosure; and

FIG. 5B is a diagram illustrating a vector quantization algorithm, in accordance with some aspects of this disclosure;

FIG. 6 is a diagram illustrating the use of groups, codebooks and blocks including a plurality of groups, in accordance with some aspects of this disclosure;

FIG. 7 is a diagram that illustrate the use of data normalization in vector quantization, in accordance with some aspects of this disclosure;

FIGS. 8A, 8B, and 8C illustrate various processes for quantizing a pre-trained model, in accordance with some aspects of this disclosure;

FIG. 9 is a block diagram illustrating an example of a deep learning network, in accordance with some aspects of this disclosure; and

FIG. 10 is a diagram illustrating an example system architecture for implementing certain aspects described herein, in accordance with some aspects of this disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Machine learning models or systems (e.g., deep neural network (DNN) models or systems, such as large language models (LLMs), convolutional neural networks (CNNs), transformers, diffusion models, etc.) can be used to perform a variety of tasks such as, for example and without limitation, generative modeling such as text-to-image generation and text-to-video generation, computer code generation, text generation, speech recognition, natural language processing tasks, detection and/or recognition (e.g., scene or object detection and/or recognition, face detection and/or recognition, speech recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

In some examples, a deep neural network model can include an LLM. LLMs can be pre-trained on large datasets and have a strong ability to generalize to a wide range of tasks when prompted appropriately. The sophistication and performance of an LLM can be based on the number of parameters (e.g., weights, biases, etc.) of the LLM. Pre-trained generative models (e.g., transformer neural network architectures, such as Generative Pre-Trained (GPT) models) have shown break-through performance for complex language modelling tasks, leading to massive academic and practical interest.

The large computational and storage costs of deep neural network models (e.g., due to the storage of large numbers of parameters, including weights, of such models) can be an obstacle to using such models. For instance, some LLMs (e.g. GPT3-175B) have in the order of 175 billion parameters and require tens-to-hundreds of graphics processing unit (GPU) years to train. Even a simple task of inferencing over a pre-trained model is highly challenging. For instance, the parameters of GPT3-175B occupy 326 GB (counting in multiples of 1024) of memory when stored in a compact floating point (e.g., float16) format. However, the amount of memory exceeds the capacity of even the highest-end single GPUs, and thus inference must be performed using more complex and expensive setups, such as multi-GPU deployments.

A standard approach to addressing overhead of deep neural network models is model compression. Neural network quantization is commonly used to reduce model footprint, data transfer and compute requirements. By quantizing a model, high bit-width floating point weights and activations that are generally used for training can be represented by lower-precision values represented by fewer bits. Current approaches generally improve inference performance of models, at the cost of introducing noise in the models, resulting in a potential drop in accuracy. Little is known about compressing such models for inference. For instance, more complex techniques for low bit-width quantization or model pruning usually require model retraining, which is expensive for large models (e.g., billion-parameter models). Alternatively, post-training techniques that can compress a model in one shot (e.g., without retraining) would be beneficial. However, such techniques are complex and challenging to scale to billions of parameters. Only basic variants of round-to-nearest quantization have been applied at the scale of large deep neural network models (e.g., GPT-175B). Such a technique may work well for low compression targets (e.g., 8-bit weights), but fails to preserve accuracy at higher rates.

Existing approaches to neural network quantization can include uniform scalar quantization, non-uniform scalar quantization, and vector quantization. Each of these approaches affect the trade-off between compression and accuracy. For uniform quantization, a symmetric uniform quantizer with b bits of precision can be used to approximate an original floating point vector x as x≈sxᵢₙₜ, where xᵢₙₜ∈[−2^{b-1}, 2^{b-1}−1] is a b-bit integer value and s is a higher precision quantization scale, shared across the components of x. Using lower bitwidths yields larger benefits, at the expense of more quantization noise, which may harm model accuracy.

Another type of quantization is non-uniform quantization. In practice, neural network weights and activations are rarely distributed perfectly uniformly. Such a non-uniform distribution can be taken advantage of to improve accuracy by non-uniform quantization. In non-uniform quantization, floating point numbers are discretized to a limited set of flexibly assigned centroids C={c₁, c₂, . . . , cₖ}. Each floating point xᵢ is then represented by the index j of the closest centroids cⱼ. Such a solution compresses the bit-width of each value xᵢ to log₂(k) and introduces extra overhead in storing a codebook C:j→cⱼ. The codebook can be stored as a look-up table.

Vector quantization is another form of quantization. A higher dimensionality can be chosen for the codebook C. Instead of mapping to a single number, d numbers can be used to map at the same time. In such cases, each centroid encodes d consecutive weights (e.g., pairs of weights if d=2). In the extreme case of cᵢ representing entire rows of a weight tensor, the approach is equivalent to vector quantization ( ).

There are variations in terms of the flexibility of a quantization grid used in neural network quantization. To compare the number of degrees of freedom for different quantization types, pairs of consecutive weights in two-dimensional space can be considered. For instance, a 3-bit uniform quantizer has 8 scalar quantization nodes. In such examples, a pair of weights effectively corresponds to 64 nodes which are arranged in a two-dimensional grid. A non-uniform quantizer with 8 nodes is a form of a 3-bit quantizer that has in two-dimensions a similar grid of 64 nodes with a less regular structure. In another example, a two-dimensional vector quantization with 64 centroids uses 3 bits per weight as log₂ (64)=6 and indices are shared among pairs of weights. The nodes are not in a grid anymore and can better represent the normally distributed data. Such a quantizer can be referred to as a two-dimensional 3-bit vector quantizer.

Various sets of possible two-dimensional quantization grids can be used for the quantization types. For example, for uniform quantization, the possible set of two-dimensional grids Gᵢₙₜ={(si, sj)} can be a pair of scaled integer values. Such a grid is equally spaced and therefore is the least flexible of the quantization types to consider.

A more flexible grid corresponds to non-uniform quantization, G_{NUQ}=c×c, where the set of possibilities is the cartesian product of the two real numbers corresponding to the centroids cₖ. Each dimension is quantized independently, however the quantization grid along each dimension is not equally spaced and follows the data distribution. For vector quantization, a two-dimensional grid G_{PQ}=(x, y) can be used, where x, y∈ [symbol] is a pair of arbitrary floating-point numbers. The two coordinates are completely independent and thus it is the most flexible type of quantization grid. The nodes are able to closely follow the data distribution. Itis noted that G_{INT}⊆G_{NUQ}⊆G_{PQ}, in which case the sets of possible grids for the three quantization types progressively extend each other. A similar observation can be made in a space of higher dimensionality. Further, increasing the dimensionality of vector quantization leads to increasingly more expressive quantization grids.

The level of quantization dimensionality affects quantization error (e.g., quantization error of neural network weights or other parameters). In some examples, signal-to-quantization noise ratio (SQNR) can be used as a metric to measure quantization error. SQNR is a normalized version of mean-squared error (MSE) mapped to log-scale. For instance, SQNR can be represented as follows: SQNR_{dB}=10 log₁₀ ( [symbol] [W²]/ [symbol] [(W−F(W))²]), where W∈ [symbol] ^{n×m} are the weights, F(·) is a quantization function, and [symbol] represents expectation over all weights.

Quantization error can be measured depending on the types of the quantization grid, as adding additional degrees of expressivity to a quantization grid can lead to lower quantization error. For instance, three quantization grid types can be compared, with each using 3-bit per weight index. The dimensionality of vector quantization can be increased, such as up to four dimensions. To make a fair comparison, the codebook size can be set such that the overhead is always 0.25 b per weight. The results of such a comparison show that the SQNR grows while extra flexibility is added to the quantization grid. The SQNR can be increased further by increasing product quantization (PQ) dimensionality. Increasing dimensionality of PQ leads to exponentially increasing codebook size. For example, three-bit vector quantizer of dimension d requires 2^{3d} centroids for the codebook. In practice, going beyond 3-bits per weight may not be feasible for four-dimensional PQ.

Systems, apparatuses, electronic devices, methods (also referred to as processes), and computer-readable media (collectively referred to herein as “systems and techniques”) are described herein for quantizing a codebook to reduce overhead (e.g., when performing quantization for pre-trained models). The systems and techniques can be used for quantization of pre-trained models. Some techniques for quantization use linear quantization for deep neural network models (e.g., LLMs). According to some aspects, the systems and techniques described herein introduce approaches to improve compression processes by using non-linear quantization and increasing the dimensionality of a representable grid with vector quantization, in which several weights are quantized together enabling a more flexible quantization-grid across several dimensions.

The systems and techniques can provide post-training quantization, allow fast non-uniform and vector quantization, and improve the performance-size trade-off significantly when compared to existing approaches. Increasing the dimensionality of quantization results in improved accuracy versus model size trade-offs for many deep neural network models (e.g., LLMs). The systems and techniques described herein provide fast and accurate post-training and vector quantization compression and achieve a state of the art for size versus accuracy trade-offs on a wide range of LLMs. The systems and techniques provide vector quantization that leads to significant memory footprint reductions and on-device timing, providing improved latency compared to a 4-bit integer baseline.

As noted previously, going beyond 3-bits per weight may not be feasible for four-dimensional PQ. Aspects described herein thus include examples with two-dimensional and four-dimensional vector quantization. However, other dimensional vector quantization can be performed according to the systems and techniques described herein.

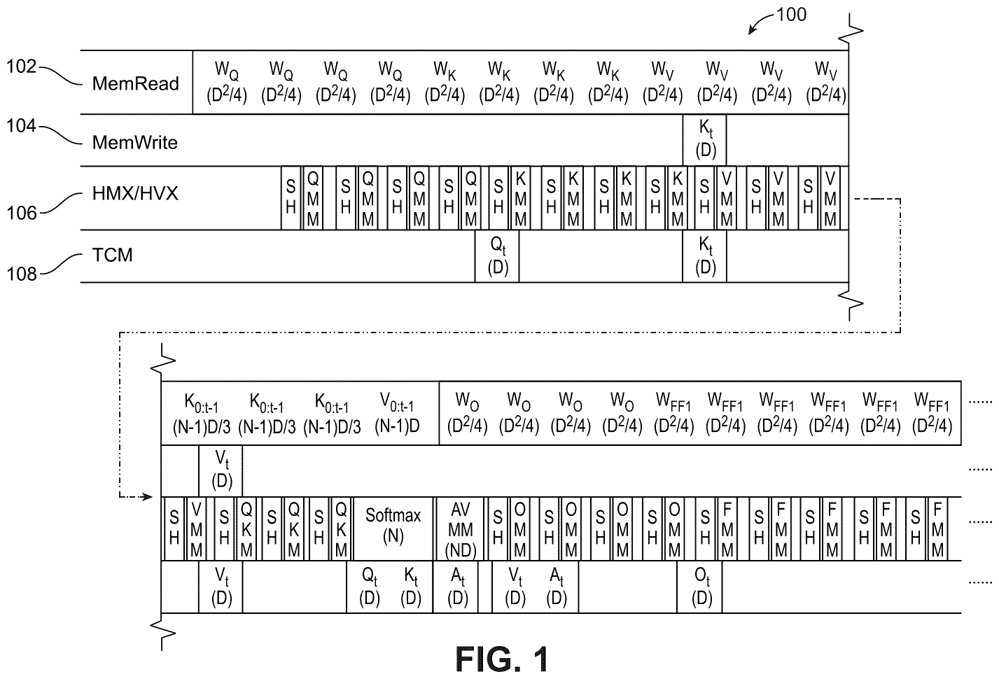

FIG. 1 illustrates a diagram 100 of LLM weight transfer overhead that occurs during inference time. Memory read 102 (MemRead) operations can be used to read parameters (e.g., weights) from memory into an array. Memory write 104 (MemWrite) operations can be performed to write data from an array to memory. In FIG. 1, the number of memory read 102 operations is high, for example compared to the number of memory write 104 operations. Hexagon Matrix eXtensions/Hexagon Vector extensions (HMX/HVX) 106 operations and periodic Tightly Coupled Memory (TCM) 108 operations are also shown in FIG. 1. HVX 106 is designed to allow significant compute workloads for advanced imaging and computer vision operations to be processed on a processor (e.g., a digital signal processor (DSP), a graphics processing unit (GPU), or other processor) instead of a central processing unit (CPU). TCM 108 provides low-latency memory access that a compute core (e.g., DSP, CPU, etc.) can use without the unpredictability of access associated with using cache memory (also referred to as cacheable memory). For example, storing data in cache memory enables fast access to the data. However, when the data is not stored in the cache, slower access to external memory is required. When using TCM 108, the access time is consistent as compared to using cache memory.

Various machine learning models (e.g., large language models (LLMs) such as GPT models, Open Pre-trained (OPT) models, etc.) can provide high quality performance across complex language modelling tasks. However, machine learning models with large numbers of parameters (e.g., LLMs) have high computational and storage costs, as illustrated in FIG. 1. For instance, due to the large number of parameters and size of such models, inference may require multiple performant processors (e.g., GPUs, DPSs, etc.), which limits the usability of such models.

As noted previously, model compression can be performed to allow large machine learning models to be used more efficiently. However, the applicability and performance of existing compression techniques is limited by the scale and complexity of large machine learning models (e.g., LLMs, such as GPT models). Various compression techniques use generative post-training quantization (GPTQ). GPTQ is a one-shot weight quantization method based on approximate second-order information. GPTQ can be both highly accurate and highly efficient. For instance, GPTQ can quantize GPT models with large numbers of parameters (e.g., 175 billion parameters) in approximately four GPU hours, reducing the bit-width to 3 or 4 bits per weight with negligible accuracy degradation relative to an uncompressed baseline. Such an approach can improve the compression gains relative to previously proposed one-shot quantization methods, preserve accuracy, allowing a large-parameter model to be executed inside a single GPU for generative inference.

A goal when compressing machine learning model weights (e.g., LLM weights) is to perform the compression with minimal loss of model accuracy. However, while various model compression techniques (e.g., GPTQ) provide reasonable accuracy in extreme quantization regimes (e.g., where weights are quantized to 2-bit or even ternary quantization levels), such techniques lead to model accuracy loss. Compression techniques are also limited to quantizing data according to a particular structure (e.g., on a column-by-column basis).

Systems, apparatuses, electronic devices, methods (also referred to as processes), and computer-readable media (collectively referred to herein as “systems and techniques”) are described herein for performing post-training quantization (e.g., on a pre-trained model) to quantize parameters (e.g., weights) of a pre-trained machine learning model (e.g., a deep neural network (DNN) model) layer by layer (or in some other fashion depending how the data is configured). In some cases, the quantization can be performed based on sampled activations without a need for end-to-end fine-tuning. In some cases, the systems and techniques can load a pre-trained model and can select or choose a layer in the model for quantization. The systems and techniques can then sample input activations to the layer. Given the layer weights W and the sampled activation X, the systems and techniques can minimize the error in the output activations for that layer. The systems and techniques can proceed layer by layer to quantize each uncompressed layer. The systems and techniques can include minimizing a second order approximation of the output. According to some aspects, the minimization can be performed using centroids and codebooks, as described herein. For instance, a Hessian matrix can be used to enable a vector quantization engine to select not just the nearest centroid to the data to minimize the weight error, but the nearest centroid that minimizes the error in output activations for that layer.

The systems and techniques disclosed herein are not limited to any specific group of weights, or to LLMs or deep neural network but can also be applied to other aspects of large amounts of data being processed where the concepts of quantization can be applied. The systems and techniques can address the use of integer quantization by enabling a plurality of columns or groups of data to be processed simultaneously and/or enabling a dynamic or adjustable quantization approach.

The systems and techniques enable the introduction of a faster and more efficient model that can be deployed on devices (e.g., mobile devices, extended reality (XR) devices, vehicles or devices or systems of vehicles, etc.), including devices with less computing resources or on an edge node of a network. The systems and techniques can operate with any type of machine learning model (e.g., a DNN, such as an LLM, a CNN, a transformer model, a diffusion model, etc.). For instance, LLMs are massively memory-bound and have a large dynamic random-access memory (DRAM) footprint. Solving such issues for LLMs can provide many benefits. For example, the disclosed systems and techniques can alleviate both the extent of the DRAM footprint and memory bandwidth of such LLMs. Applying the systems and techniques can allow larger machine learning models (e.g., DNNs, such as LLMs) to be run on computing devices. The systems and techniques can also increase tokens per second for LLMs that can already run on existing computing devices. In some aspects, at inference time in machine learning models, use of vector quantization can reduce the overhead used to perform the inference operation.

Various aspects of the application will be described with respect to the figures.

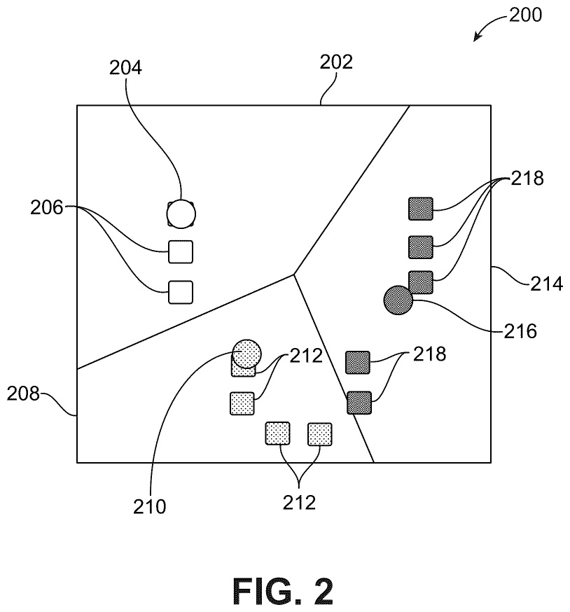

FIG. 2 illustrates an example of vector quantization (e.g., for compressing multi-dimensional data). Vector quantization is used for data compression where in some aspects, data is clustered using a classic K-means algorithm. The K-means algorithm involves grouping similar pixels into K clusters. Each cluster has a centroid that represents a representative shading for the pixels in the cluster, and one can map each pixel to the closest centroid. The approach reduces the number of shades required to represent the image, and thus the size of the image data. FIG. 2 illustrates a group of clusters 200 that includes a first cluster 202 with a first centroid 204 with a first set of data 206. A second cluster 208 includes a second centroid 210 and a second set of data 212. A third cluster 214 includes a third centroid 216 and a third set of data 218. Each centroid can be used to approximate the neighboring data. When encoding, one can encode data related to the weight of each set of data including the first set of data 206, the second set of data 212, and the third set of data 218 by an index associated with the respective centroid, such as the first centroid 204, the second centroid 210, and the third centroid 216. In some examples, the number of centroids can be arranged as a power of 2 (e.g., 2, 4, 8, 16, etc.). A codebook can be stored which includes data for the coordinates of each of the respective centroids such as the first centroid 204, the second centroid 210, and the third centroid 216.

In some aspects, each data point can be represented using the associated centroid: W∈ [symbol] ^{r×c}=>(Reshape) W∈ [symbol] ^{n×d} where the data is reshaped from a row-by-column structure to a certain dimensionality of an array or matrix with n×d dimensions. One can choose parameters for the reshaping and other processes that include one or more of: vector quantization (VQ) dimensionality d, the number of cluster k, the group size 1, and the codebook bit-width b.

Storing the codebook which corresponds to the coordinates of the respective centroids can be seen as overhead in which the bit used per weight element can be represented by log₂ k+(k*d*b)/l.

Systems and techniques are described herein for providing an approach to quantizing a pre-trained machine learning model (e.g., parameters of the model, such as weights), such as a DNN (e.g., an LLM, such as a generative LLM). For instance, the systems and techniques can perform quantization in such a way as to reduce its memory overhead during processing and to increase the number of tokens per second that can be generated by the model at run-time. As described in more detail herein, the described systems and techniques allow lower error of compression to be achieved. For example, each tensor (which represents a large amount of the data related to the coordinates of respective centroids) can be chunked or broken up into groups. Each group can be assigned a respective code book as part of the compression process. In some aspects, each group of a plurality of groups includes a plurality of columns associated with the data (e.g., columns of weights). The codebook assignment can include a scaling step in which data is scaled and then a codebook is assigned across at least two columns of data in a group such that a matching codebook for the plurality of columns is selected such that a centroid can be obtained that minimizes the output loss.

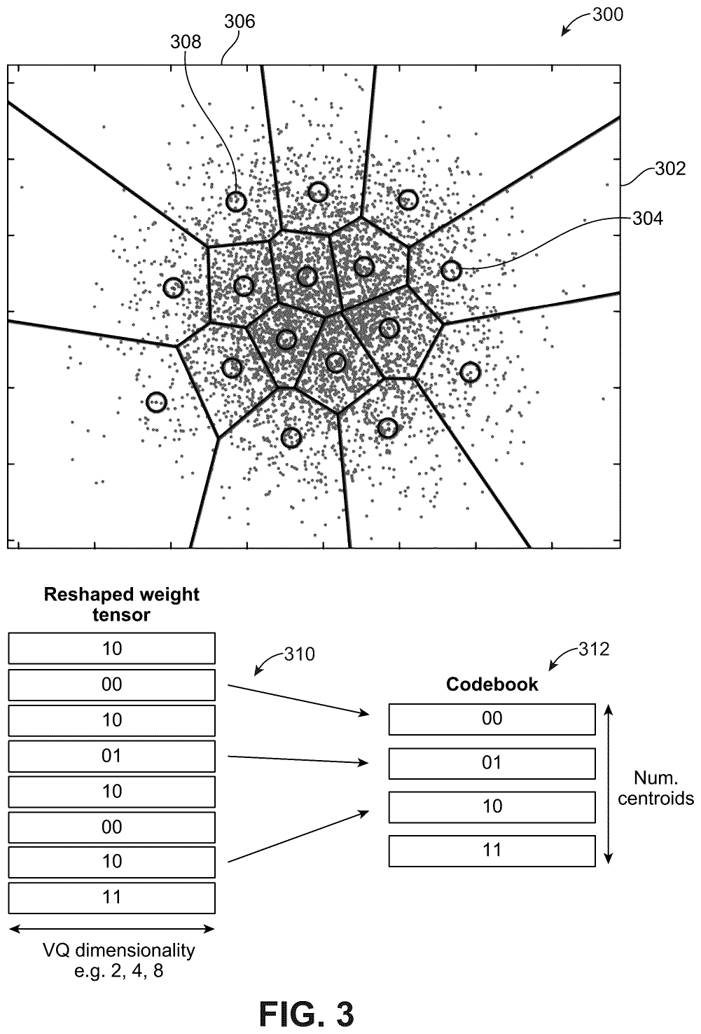

FIG. 3 is a diagram illustrating a vector quantization processing according to some aspects of this disclosure. A data field 300 includes a first cluster 302 showing a first centroid 304 and a second cluster 306 with a second centroid 308. Other clusters and centroids are shown as well. The data field 300 illustrates how the use of centroids can be implemented in the disclosure in connection with a codebook to select centroids as part of the quantization process that minimizes the output reconstruction error for a pre-trained model. A reshaped weight tensor 310 is shown with various values that conform to a vector quantization dimensionality (e.g., 2, 4, 8, etc.) that can correspond to a codebook 312 with various values according to a number of centroids.

The systems and techniques described herein can be applied to any vector quantization approach where codebooks are used. In some examples, a quantization approach can include generative post-training quantization (GPTQ), also referred to in some cases as generative post-training vector quantization (GPTVQ).

As described above, quantization introduces quantization noise. Techniques can be used to mitigate the effects of quantization noise on model accuracy. Post-training quantization (PTQ) approaches aim to mitigate the adverse effects of quantization noise on pre-trained networks, without having to resort to costly quantization-aware training (QAT). In some cases, PTQ can be performed by modifying weights to minimize a layer's output error as an approximation to the full network's loss, such as using the following:

$$𝔼 [ ℒ ( θ + ϵ ) ] = {\sum }_{ℓ} {‖ {W}^{ℓ} {X}^{ℓ} - {\hat{W}}^{ℓ} {X}^{ℓ} ‖}_{{F}^{′}}^{2} \qquad ( 1 )$$

where [symbol] is the weight (e.g., weight tensor) for layer [symbol] , [symbol] = [symbol] + [symbol] is the (quantized) approximation to the weight tensor, and X^{l} of shape I×N denotes the input data for layer [symbol] from a calibration dataset, with N individual data points of dimensionality/along the columns.

GPTQ follows Optimal Brain Quantization (OBQ), a Hessian-based quantization method, in using the inverse Hessian matrix (denoted as H⁻¹) of Equation (1). The Hessian matrix can be efficiently computed as [symbol] = [symbol] . Like OBQ, GPTQ aims to minimize the Hessian-weighted error introduced by quantizing weights in [symbol] , such as using the following:

$$E = {\sum }_{q} {\vert {E}_{q} \vert}_{2}^{2} ; {E}_{q} = \frac{{( {W}_{: , q} - quant ( {W}_{: , q} ) )}^{2}}{{[ {H}^{- I} ]}_{q q}} . \qquad ( 2 )$$

GPTQ extends OBQ in the following ways. For example, GPTQ exploits the fact that the Hessian matrix [symbol] is shared over all rows of [symbol] by quantizing all weights in a column in parallel, from left to right. After quantizing a column q, all remaining (unquantized) columns q′>q are modified with a Hessian-based update rule δ that absorbs the error introduced by quantizing column q on the layer's output, such as follows:

$$δ = - \frac{{W}_{: , q} - quant ( {W}_{: , q} )}{{[ {H}^{- 1} ]}_{q q}} {H}_{: , ( q + 1 ) :} \qquad ( 3 )$$

To reduce data transfer, GPTQ can apply the update of Equation (3) only to a small block of B columns in which column q resides. To update the columns outside of block B, the errors E_{q} in Equation (2) are accumulated while the columns in block B are processed, and are applied to all columns (e.g., to all columns at the same time) outside of block B after all columns in block B are processed. GPTQ can also use a Cholesky decomposition of the inverse Hessian H⁻¹, which introduces a more numerically stable alternative to the inverse Hessian row and column removal operations.

In some aspects, the error of vector quantization can be computed as follows:

$${‖ W - \hat{W} ‖}_{F}^{2} = {\sum }_{j} {‖ {w}_{j} - c ( {w}_{j} ) ‖}_{2}^{2} \qquad ( 4 )$$

Equation (4) provides a formula for computing error of vector quantization (e.g., representing the data using the set of cluster centroids). In some cases, the equation can be attributed to both encoding and decoding.

In some cases, a lossy data compression method can be used, where each vector is mapped to a centroid from the codebook. Using such an approach, arbitrary dimensionalities are possible. In some examples, encoding can be performed using K-means clustering. In some cases, an objective for generating the codebook can be minimized using E- and M-steps, where a system can update centroid assignments an E-step and can update the centroids within the centroid assignments in an M-step. For instance, the E-step can include assigning the datapoints to the closest cluster. The M-step can include computing the centroid of each cluster. After implementing the E-step and the M-step, the data field 300 can result with the organized clusters of data and the respective centroid for each cluster.

Clustering is an exploratory data analysis technique used to get an intuition about the structure of the data. It can be defined as the task of identifying subgroups in the data such that data points in the same subgroup (cluster) are very similar while data points in different clusters are very different. The approach is to try to find homogeneous subgroups within the data such that data points in each cluster are as similar as possible according to a similarity measure such as Euclidean-based distance or correlation-based distance. The decision of which similarity measure to use is application specific.

In decoding, the approach can be performed using a look-up table with n-dimensional vectors. Each vector is encoded by its position in the codebook and the codebook does take some extra overhead memory which is taken into account in the overall benefit of this approach.

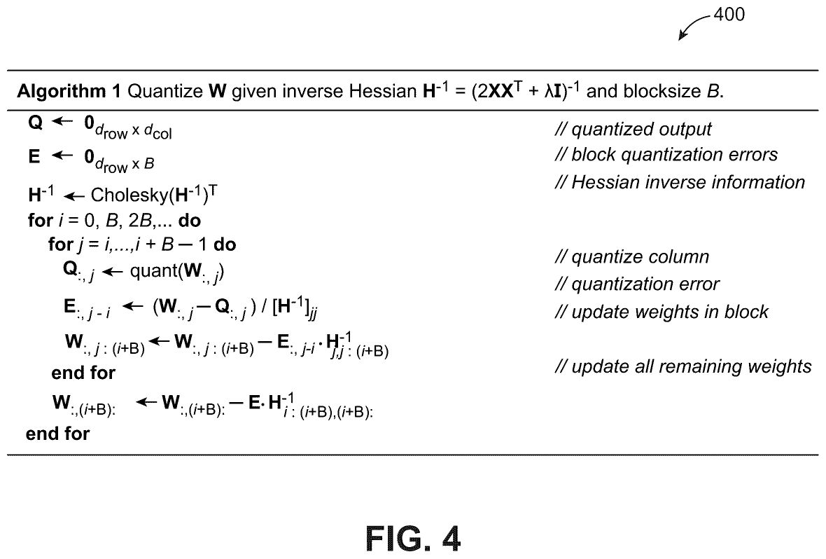

FIG. 4 illustrates an algorithm 400 for performing GPTQ using a method for integer post-training quantization. The quantization in this approach is performed on a column-by-column basis as the remaining weights are updated. The algorithm 400 for performing GPTQ relates to quantizing W given an inverse Hessian matrix H⁻¹=−(2XX^{T}+λI)⁻¹ and a blocksize B. The inverse matrix Hessian H⁻¹ is a matrix that is the reciprocal of the Hessian matrix. The Hessian matrix is a square matrix of second-order partial derivatives of a scalar-valued function. The Hessian matrix provides information about the local curvature of a function at a particular point. The algorithm includes quantizing an output on a row and column basis, determining block quantization errors, obtaining the inverse Hessian matrix information on a block by block basis, and for each pair of blocks (B, 2B, etc.) such as when the dimensionality of vector quantization is two-dimensional, quantizing on a column-by-column basis, determining a quantization error, updating the weights in the block associated with a particular layer and then update all remaining weights. The process incorporates the error in a particular layer into the other layers by updating remaining weights in uncompressed layers. The approach accumulates the error for the particular column and then updates the remaining columns based on that error. The Hessian matrix-based function can be based on a loss function approximation. In some aspects, updates to the remaining weights are performed in sub-blocks for efficiency purposes.

The systems and techniques described herein can be used to minimize part of the algorithm 400 for performing GPTQ to avoid the introduction of error during the compression. The approach is to not necessarily minimize the loss function directly but minimize its second-order approximation, in which case the Hessian matrix is used. The systems and techniques are different from previous approaches, in part because the loss function is related to a loss generated by quantizing the weights, whereas the disclosed approach involves minimizing a loss in the output of the data.

The GPTQ method can be a generalization of the GPTQ method for nonuniform and vector quantization. For instance, following the GPTQ framework quantization of the weight tensor can be performed in a greedy manner starting from the first column. Given the PQ dimensionality d, d columns can be quantized at a time. In the case of scalar quantization, the optimal Hessian-weighted quantization was achieved by rounding to the nearest. However, vector quantization simply choosing the nearest centroid might be suboptimal as an error in each d coordinate is weighted differently. The following rule can be used for choosing the optimal assignment j for a data point x⁽ⁱ⁾ and the corresponding sub-Hessian H⁽ⁱ⁾:

$$j = arg {{min}_{m} ( x - {c}^{( m )} )}^{T} {H}^{( i )} ( x - {c}^{( m )} ) . \qquad ( 4 )$$

After performing quantization of d columns, the remaining weights can be updated using an update rule. The update can be accumulated along d coordinates and can be applied on the remaining weights (e.g., as a single operation).

To minimize the quantization error, several codebooks per layer can used. Each codebook is assigned to a group of weights. While, compared to scalar quantization, the granularity of the remaining weights is increased if d>1.

Codebook initialization can also be performed. To initialize the codebook for a group of weights, one example approach is to use the following clustering method related to weighted K-means. Given the set of d-dimensional vectors x⁽ⁱ⁾, k centroid vectors c^{(m)} and the corresponding sets of assignments Iₘ can be determined. An objective can be defined as the following sum of Hessian-weighted distance functions between the data points and the centroids:

$${min}_{I , {c}^{( 0 ) , … ( k )}} , {\sum }_{m = 0}^{k} {\sum }_{i ϵ {I}_{m}} {( {x}^{( i )} - {c}^{( m )} )}^{T} {H}^{( i )} ( {x}^{( i )} - {c}^{( m )} ) , \qquad ( 5 )$$

where H⁽ⁱ⁾ is a d×d subset of the inverse Hessian matrix corresponding to the data point xⁱ. In some cases, for two-dimensional vector quantization, these matrices are shared among pairs of columns.

The objective can be minimized using E- and M-steps. For example, E-step can include finding the assignment j for each unquantized d-dimensional vector x⁽ⁱ⁾ that minimizes an objective. Using the distance function above assigns optimal centroids based on the data-aware loss. The M-step can include finding the centroid value c^{(m)} that minimizes the following:

$${c}^{( m )} = arg {min}_{{c}^{( m )}} {\sum }_{i ϵ {I}_{m}} ( {x}^{( i )} - {c}^{( m )} ) {H}^{( i )} ( {x}^{( i )} - {c}^{( m )} ) \qquad ( 6 )$$

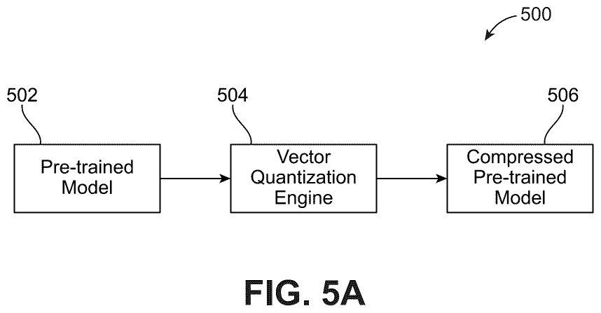

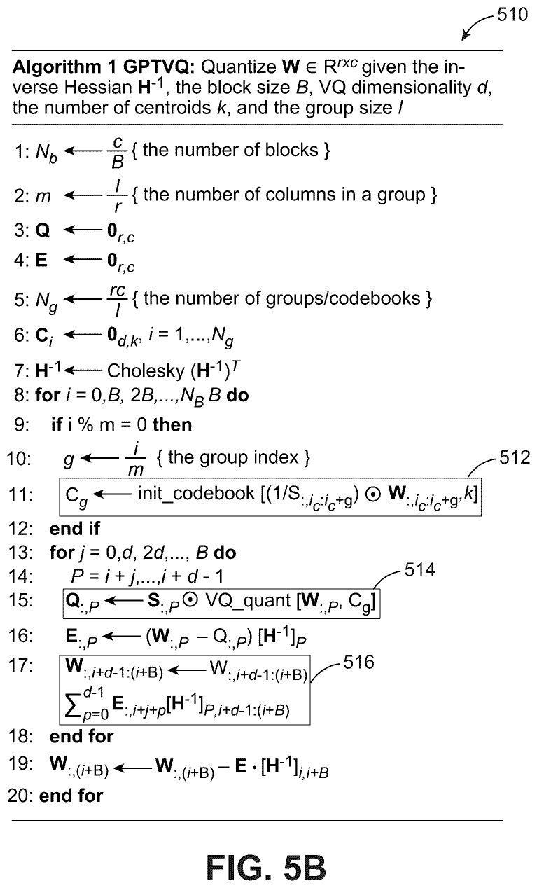

The objective is a quadratic form with respect to c (i). The optimal value is computed in a closed form as c^{(m)}=(Σ_{i∈l}_{ₘ}H⁽ⁱ⁾)⁺(Σ_{i∈l}_{ₘ}H⁽ⁱ⁾x⁽ⁱ⁾), where (·)⁺ is a Moore-Penrose pseudoinverse. In some cases, during the vector quantization operation on line 15 in FIG. 5B, the assignment step defined in Equation (4) can be used. The Hessian matrix diagonal or the full d-dim sub-Hessian matrix can be used.

In some cases, block-wise VQ data normalization can be performed. In order to lower the error of vector quantization, block-wise data normalization can be applied to the data before the codebook initialization. For each group corresponding to a new codebook, element-wise division Wᵢ⊙(1/Sᵢ) of the weight sub-matrix matrix Wᵢ and the corresponding scales Sᵢ can be performed. The scale can be computed block-wise for every sub-row of Wᵢ, e.g., for a block size of 16, 32, or 64.

Given a set of blocks (sub-rows) w⁽ⁱ⁾, the scale sⁱ for each of the set of blocks is computed as s⁽ⁱ⁾=maxⱼ|wⱼ⁽ⁱ⁾|. In order to minimize the overhead, the scales are quantized to four-bit integer. In some cases, quantization can be performed in log-scale to capture several orders of magnitudes in weights. The quantized scales are computed as

$${S}_{i n t}^{( i )} = ⌈ \frac{{log}_{2} [ {S}^{( i )} ] - z}{a} ⌉ a ,$$

where a is the quantization scale shared within the group of weights. To accurately represent zero in log-space, which corresponds to unit scaling, the floating-point offset z can be used. The value of z is shared within the columns of W and thus has negligible overhead. The scaled sub-row can be normalized as

$$w \cdot {2}^{- {as}_{int} - {S}_{0}} ,$$

where s₀=log₂(z). The scaled data is used for codebook initialization. The inverse scaling is applied at PQ decoding step.

According to the algorithm 400, the vector quantization engine 504 (shown in FIG. 5A) quantizes multiple columns (two or more columns) at a time. If the data include a vector of “d” dimensions, the vector quantization engine 504 can quantize the vector and the d values are in the same row. Instead of processing column by column, the vector quantization engine 504 can process two-columns by two-columns by two-columns. In other cases, the dimension d may be 3, 4, or higher and the process could proceed for every three or four columns. In this regard, a chosen codebook spans multiple columns to correspond to multi-column data.

The output of the algorithm 400 is a set of quantized weights of a model or for a given dataset. In some cases, uniform quantization can be performed. However, any quantization method can be used for vector quantization. In some aspects, the systems and techniques described herein can determine a quantized weight that reconstructs the output as closely as possible or with minimal error. For example, the systems and techniques can find a quantization value that minimizes the output reconstruction error rather than minimizes the weight reconstruction error.

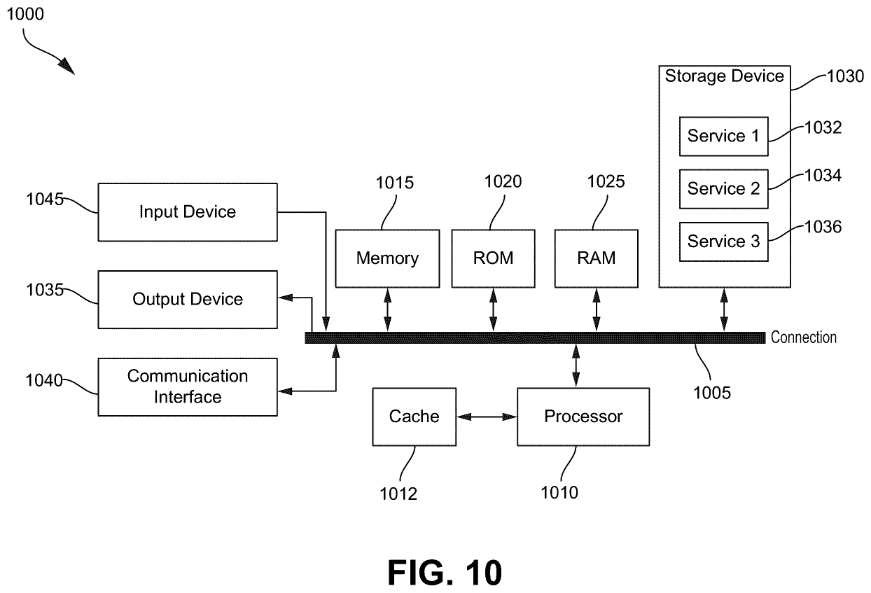

FIG. 5A illustrates a system 500 including input data of a pre-trained model 502 that is provided to a vector quantization engine 504. The vector quantization engine 504 can be a computing system 1000 (see, e.g., FIG. 10) configured for performing vector quantization through the combined use of hardware components configured through a module or software programming to perform the vector quantization operations disclosed herein. The output of the vector quantization engine 504 can be a compressed pre-trained model 506.

FIG. 5B illustrates an example algorithm, such as a vector quantization algorithm 510, which operates to quantize input data (e.g., W∈ [symbol] ^{r×c}, or weights in a row by column matrix) given the inverse Hessian matrix H⁻¹, a block size B, a vector quantization dimensionality d, a number of centroids k, and a group size 1. As shown in the vector quantization algorithm 510, rows 1-7 include various operations such as determining the number of blocks N_{b}, the number of columns in a group m, quantization values and error values, the number of groups/codebooks Ng, a value for a code book Ci, and the inverse Hessian matrix H⁻¹.

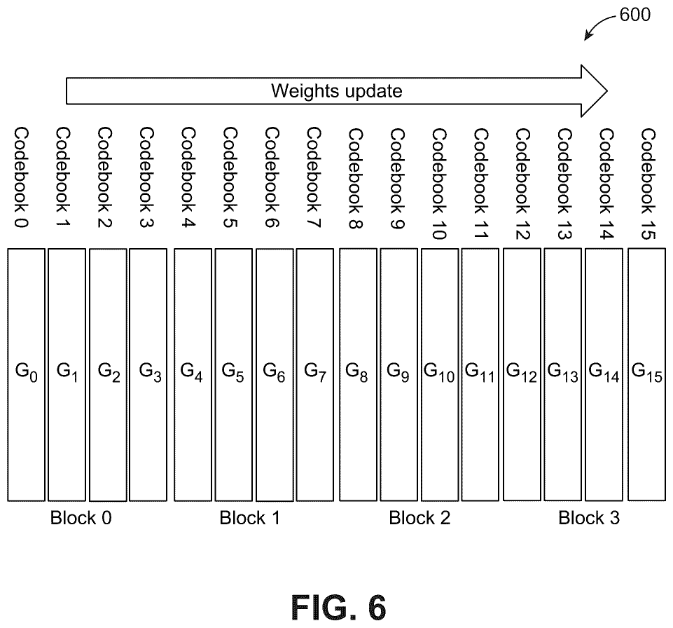

The discussion of FIG. 5B can be understood further with reference to FIG. 6, which shows a set of blocks 600 in which a block 0 includes four groups G₀, G₁, G₂, G₃. Each of the groups G₀, G₁, G₂, G₃ is assigned a respective codebook 0, codebook 1, codebook 2, and codebook 3. Each respective group can include multiple columns. While FIG. 6 illustrates a block including a plurality of groups of weights (G₀, G₁, G₂, G₃) corresponding to a plurality of codebooks (codebooks 0-3), in some cases a block group of weights can include multiple blocks. As noted herein, systems and techniques described herein can quantize multiple columns (e.g., two or more columns) at a time, which can mean selecting a corresponding codebook for data spanning multiple columns. A weight update is shown as moving from left to right. For example, the systems and techniques can arrange or organize the data from the pre-trained model into groups and blocks as shown in FIG. 6. The systems and techniques can then take a plurality of columns in a group (or in another aspect, a plurality of groups) and perform quantization according to the algorithm. The systems and techniques can update the weights in the current group or current plurality of columns and can update the remaining weights in the other remaining groups or columns based on the updated weights from the current group or plurality of columns. For example, the systems and techniques can include quantizing the data in group 0 and group 1, generating an error value and then updating, based on the error, the weights in groups 0 and 1 and then update the weights in group 2-group 15. The systems and techniques can quantize the data in groups 2 and 3, generating an error, and updating, based on the error, the weights in groups 2 and 2 and then update the remaining group 4-group 15.

As noted previously, while FIG. 6 illustrates aspects where one block contains several groups, the reverse can also be used in some cases (where a group is associated with multiple blocks). Further, the systems and techniques can be based on the use of columns for vector quantization in which quantization occurs over multiple columns, then the weights of the multiple columns are updated, and then the data in remaining columns are updated to incorporate the loss value from the current quantization on the output reconstructions.

The systems and techniques can also include importing a Hessian matrix for a block, based on the block structure shown in FIG. 6. Each block can cover multiple groups as shown. Each block can have a respective inverted Hessian matrix for use in the codebook assignment, quantization and/or other processes.

With the concepts of FIG. 6 in mind, lines 8-12 in the vector quantization algorithm 510 of FIG. 5B operates for each block to initialize a group index and then for each block, or for the groups in the block, to initialize or assign a codebook C_{g} 512. The term C_{g} refers to the codebook (e.g., codebooks 0-15 in FIG. 6) respectively assigned to groups 0-15 in FIG. 6. In other words, since there is a codebook per group, when the vector quantization engine 504 comes to a first column in a new group, then the codebook is initialized for that group of data in the first column. Part of the process of assigning a codebook C_{g} 512 can including a scaling operation (e.g., a scaling down operation) of the data using the value 1/S as shown in line 11. The approach enables the vector quantization engine 504 to absorb changes in the columns in the current group after quantizing the data in the previous groups.

After all the codebooks are assigned to groups and/or columns in groups, then lines 13-18 involves operations such as, on a vector quantization dimensionality d (see line 13), quantizing 514 the data W using a vector quantization approach and using the codebook C_{g} for the respective group or plurality of columns in a group. The quantizing 514 can include reference to a metric used for centroid assignment. For example, the following equation can be used to identify a value 1 which can be a nearest centroid Cᵢ in the codebook relative to the data Wᵢ as follows:

$$l = arg {{min}_{l} ( [ {C}_{i , : , l} - {W}_{: , P} ] ⊙ {S}_{: , P} )}^{T} {( {H}_{P}^{- 1} )}^{- 1} ( [ {C}_{i , : , l} - {W}_{: , P} ] ⊙ {S}_{: , P} ) \qquad ( 7 )$$

where S denotes a scaling factor, (H_{P}⁻¹)⁻¹ denotes a Hessian matrix, and the arg min operation denotes a determination of a minimal distance between data W and a centroid C. Using equation (7), a system can determine which value (which centroid in the codebook) is closest to the W value (and that minimizes the output error) and the vector quantization algorithm 510 quantizes to that value. When performing the error evaluation in line 16, the vector quantization algorithm 510 uses the inverse Hessian matrix [H⁻¹]_{P}, which then weighs what is considered the closet centroid. The approach in line 17 can include reweighing the distance between the original vector and all the centroids which can make the vector quantization engine 504 chose a different centroid because a certain centroid minimizes essentially the output error. The approach enables the choice of a centroid to represent the original weights that minimize the output error as opposed to the weight construction error.

Using the inverse Hessian matrix diagonal in equation (7) can weigh or determine what is considered close in terms of a distance from a vector including the original data to the nearest centroid. Use of the Hessian matrix (H_{P}⁻¹)⁻¹ can cause a different centroid to be chosen which is based on how that centroid minimizes the output error. In other words, the centroid can be chosen not based on specific distance to the vector but can be chosen as a centroid that represents the initial weight while minimizing the output error.

The vector quantization engine 504 is configured to find the vector that best represents the vector centroids of the set of centroids that best represents the original two values of the data. The traditional way to do the evaluation is to look at which vector is just closest to the original value. But the disclosed approach includes determining what the effect is of choosing a specific vector on the output so that the vector quantization engine 504 can reweight it with the Hessian matrix which encapsulates information learned from the data that is fed through the network. The vector quantization engine 504 can choose the vector that best reconstructs the output instead of the vector that best reconstructs the original weight tensor. Again, the selection of a centroid traditionally can be one or a set of centroids that best represents the original weights where one chooses the centroid that is closest to the original weight. However, using the Hessian matrix can provide information regarding the effect of picking a respective centroid on the output. The vector quantization engine 504 can therefore choose the centroid (or set of centroids or vector) that best reconstructs the output, rather than the centroid or vector that best represents the original weight data.

The scaling that is described for row 11 can be used because there are multiple columns being processed simultaneously. By scaling the data, it becomes easier to identify a shared codebook for the plurality of columns. The scaling ensures that there are no outlier values which makes it more difficult to find a shared codebook across multiple columns.

Quantization parameters can be set for a smaller group of weights based on a group definition, and thus the approach can provide better performance. If there is a codebook for a smaller group of weights, the use of the codebook can give better performance on processing the unquantized values. Rather than using uniform integer quantization, the approach can include the possibility of using non-uniform quantization across a vector quantization dimension d or a two-dimensional vector quantization can be used as well, meaning that a plurality of columns or dimensions can be processed simultaneously.

Line 16 of the vector quantization algorithm 510 can evaluate an error in the results of line 15 regarding quantization. The error can be used in line 17 as part of weight updating 516 which involves updating the weights in the respective block or group. Then, the remaining weights of unquantized groups or blocks are updated in line 19 of the vector quantization algorithm 510. The vector quantization algorithm 510 is used for compression or quantizing of the data or the weights. A set or array of indices would be stored at the end of the process which would represent a compressed set of data. For each index, one could look in the codebook and then fetch a two-dimensional vector. One look-up table per group would be used, or one codebook per group.

Note that the error in line 16 of vector quantization algorithm 510 differs from the error E used in the algorithm 400 in FIG. 4. The vector quantization algorithm 510 at line 16 finds a quantization value that minimizes the output reconstruction error rather than minimizes the weight reconstruction error as in the algorithm 400. A certain quantization choice affects the output, and one can precompute the Hessian value related to quantization of a column of the weight matrix and how the quantization effects the output.

In some aspects, the approach shown in FIG. 5B can use a Hessian matrix just for the block, so that one does not have to use the whole Hessian matrix but can just use the Hessian matrix on a block basis which is much smaller and easier to process.

After the procedure in FIG. 5B is completed, the system can perform several steps to further improve model size vs perplexity trade-offs. The system can perform codebook fine-tuning to reduce output reconstruction error. In line 15 of FIG. 5B, Q is incrementally constructed from the elements of C. Since this construction constitutes a look-up of values in C, the layerwise objective can still be minimized with respect to C. The objective can be a quadratic program that is convex, which can be represented as:

$${min}_{{C}_{0} , … , {C}_{N}} {‖ WX - QX ‖}_{F}^{2} , \qquad ( 7 )$$

where Q (C₀, . . . , C_{N}) is a look-up operation reconstructing the quantized weights from the centroids. While this objective can be minimized in a closed form, that gradient descent is considerably faster and yields equally good solutions. The gradient of Q with respect to C can be defined simply as constructing Q only involves a look-up operation. In each GD step, the values in C are updated, and Q is reconstructed using the new values in C, keeping the assignments fixed.

In practical scenarios, codebooks can be quantized to eight bits. As a further post-processing step, the system can quantize the codebook for each group of weights to signed eight-bit integers, using symmetric min-max quantization.

Further codebook compression can be performed as well. One can achieve improved model size vs perplexity trade-offs by reducing the rank of the codebook tensor C. For single tensor, C has shape N_{G}×K×D, where N_{G} is the number of groups in the corresponding weight tensor, K is the number of centroids per codebook, and D is the VQ-dimension, ≥1. The system can first sort the second dimension of C by the first value along the third dimension and reassign the indices in I accordingly. Then, the system can perform SVD on every N_{G}×K matrix along the third dimension, leading to matrices U_{d}, Σ_{d} and V_{d}, for d=1 . . . D, of shapes N_{G}×K, K×K and K×K, respectively. The system can then fold Σ into U as U′=UΣ, and rank reduce the matrix to rank k, yielding a N_{G}×k shaped matrix U″. One can rank reduce V accordingly, yielding K×k matrix V′.

Then, the system performs gradient descent on the loss of equation (7), but with respect to the codebook tensor factors U″ and V′. In each GD step, Ĉ is created as Ĉ=U″V′^{T}, and the rest of the codebook fine-tuning procedure as described earlier is followed. Lastly, only the codebook tensor factor U″ is quantized, as V′ gives very little overhead. During inference, Ĉ is quantized per codebook after construction. In some cases, such a step can be applied to 1-D VQ only.

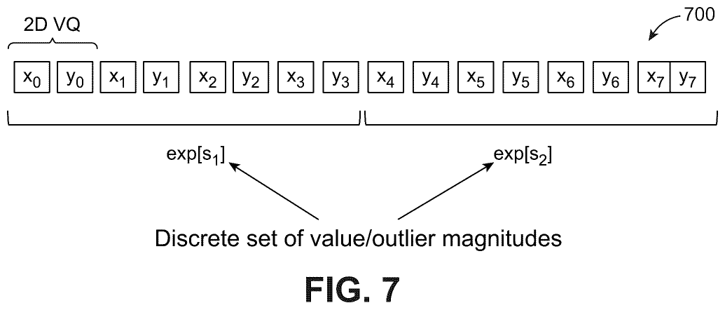

FIG. 7 illustrates data normalization for vector quantization 700. Each row in a respective group in the weight matrix can be split into scale-blocks (e.g., 8 or 16 weights). The data within the block (e.g., the blocks shown in FIG. 6) can be normalized or scaled by a scale value S. The scale value S can refer to the S value in lines 11 and 15 of the vector quantization algorithm 510 (e.g., FIG. 5B). The scale can be computed as a maximal element in the block or data in a group or in a plurality of columns within a group. Using the maximal element in the scale-block can take care of outliers in the data and make the approach easier for finding a centroid from the codebook. For example, if in the scaling all the values are transitioned or scaled to values from 0 to 1, then the maximum element of data in the scale block will scale to the value of 1. In some aspects, the scale can be quantized aggressively (e.g., 4 bits or 16 values using integer quantization) to minimize the overhead in terms of storing the scale. As shown in FIG. 7, the scale can be quantized in log scale, so different scales correspond to different exponent values. Shown are values s₁ and s₂, which are a discrete set of value/outlier magnitudes. In the encoding and decoding (e.g., lines 11 and 15) of the vector quantization algorithm 510, the data normalization shown in FIG. 7 can be used to reduce overhead. In the example, the block size can be 16 with a 4-bit scale. In such a case, normalization can be performed per group with 1024 rows. The overhead in the example can be: 4b/16 weights+16b/1024 rows (quantizer scale)=0.25b+0.016b≈0.27b per weight, or in other words, 0.27 bits per weight of data in the pre-trained model. The vector quantization engine 504 also needs to store the quantizer scale. The 1024 rows shown above for storing the quantizer scale results in an overhead of 0.27 bits per weight. The normalization overhead is on top of the overhead of vector quantization. Thus, the data normalization or scaling as part of the encoding and decoding process helps to reduce the overhead.

Again with reference to FIGS. 5A-6B, in some aspects, the quantization or compression approach can involve groups and blocks (e.g., as shown in FIG. 6). In some aspects, the approach could involve layers of a model such as an LLM. For example, the workflow could include loading a pre-trained model into a vector quantization engine 504 and choosing a layer. The vector quantization engine 504 could obtain some input data and sample the input data to generate activations to the layer. The vector quantization engine 504 could select a vector quantization dimensionality, a group size, a codebook bit-width and a scale groups size. These parameters can be used by the vector quantization engine 504 to generate or define a compression ratio. The vector quantization engine 504 can then quantize or compress the weights in the layer using a particular method. The weights can be updated for that layer, and then the weights for the remaining layers can be updated based on the error value. The vector quantization engine 504 can then proceed to the next uncompressed layer performing a similar process of quantization, obtaining an error, updating that layer's weights and then updating the other remaining unquantized or other uncompressed layers.

The scaling concepts disclosed herein provide a benefit of ensuring that the weights in the multiple columns are generally of a similar magnitude. If one column has weights that are much larger weights than the next column, then it can be difficult to find a shared code book for the two columns. However, when the vector quantization engine 504 scales the columns or the groups of weights as in line 11 of the vector quantization algorithm 510, and shapes of weights, then the scales of the weights become more similar, and it can become easier to quantize the weights using vector quantization. Line 11 includes the division by a scaling factor S and then reconstruction occurs at line 15 where, as part of the quantizing step, the weights are multiplied by S.

Normalized data on a sphere or in a circle (data normalization can enable the data to be distributed across a sphere or circle for further processing) is generally much easier to quantize using the codebook or centroid approach when compared to data scattered all around on a plane. Data normalization can move the data into scale books and then for each of the scale books can be the size of eight to sixteen, for example. When the data is normalized by the scale, the vector quantization engine 504 can use more elements in the scale book which allows the vector quantization engine 504 to take care of the outliners. If the data includes an unusually large value, the scaling process causes the large value to be assigned a value of one. The large value may be assigned a different value in some cases. Normalization enables all the values to be quantized and prevents a single outlier from having an unusually large value to cause errors. After the values are scaled, there is some overhead in storing the scale itself and the scaled values. The vector quantization engine 504 can quantize the values and the lock the scale. In a decoding step, the approach can be to multiply by the scale as in line 15 of the vector quantization algorithm 510.

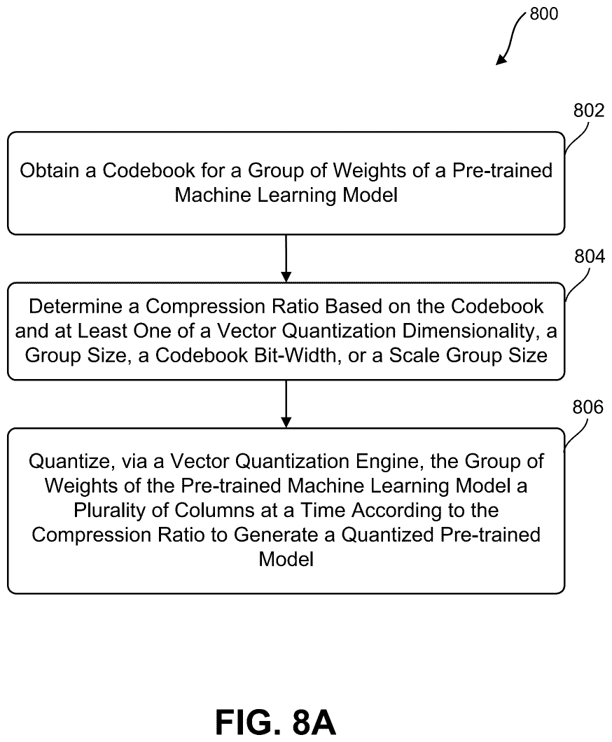

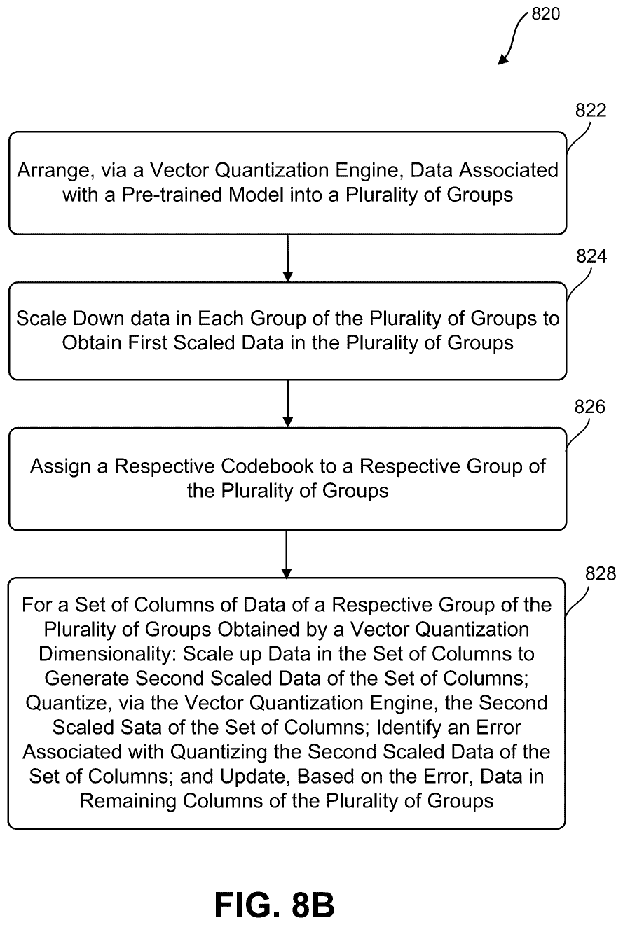

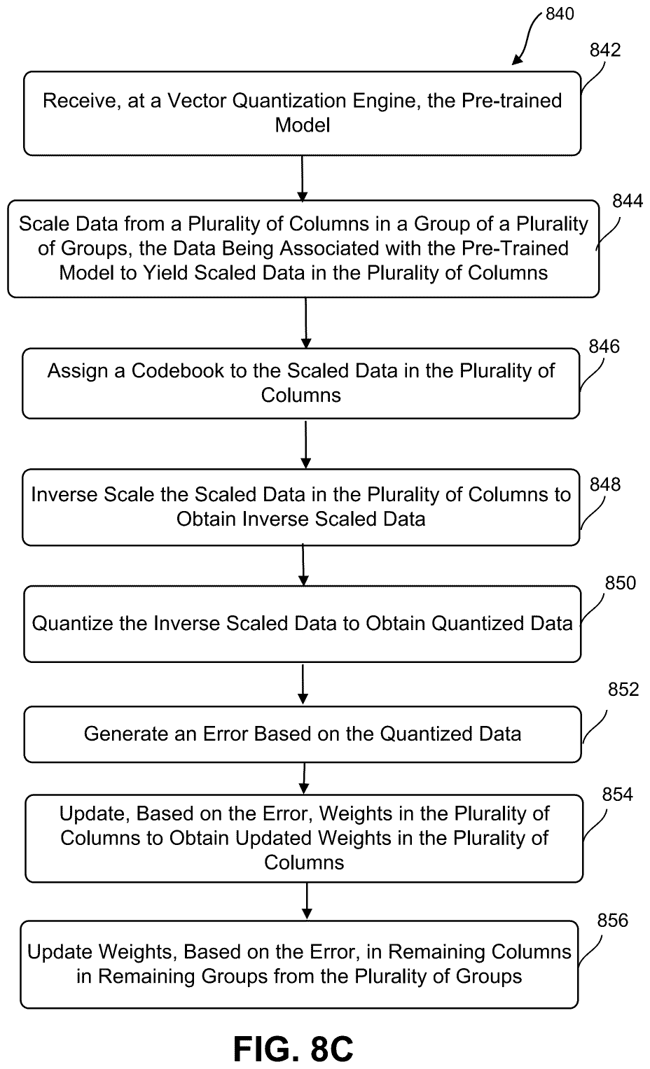

FIGS. 8A-8C illustrate various processes related to quantizing a pre-trained model. FIG. 8A is a flowchart illustrating an example process 800 for quantizing pre-trained models using one or more of the techniques described herein. In one example, the process 800 can be performed by one or more of the vector quantization engine 504 (e.g., FIG. 5A), the computing system 1000 (e.g., FIG. 10), at least one processor 1010 of the computing system 1000, or a combination thereof. For instance, a computing device with the computing device architecture of the computing system 1000 shown in FIG. 10 can implement the operations of FIG. 8A, FIG. 8B, FIG. 8C and/or the components and/or operations described herein with respect to any of FIGS. 2, 3, 4, 5A, 5B, 6, 8A, 8B, 8C, and/or 9.

At operation 802, an apparatus or system (e.g., the vector quantization engine 504, the computing system 1000, or at least one subsystem thereof) can be configured to obtain a codebook for a group of weights of a pre-trained machine learning model.

At operation 804, the apparatus or system (e.g., the vector quantization engine 504, the computing system 1000, or at least one subsystem thereof) can be configured to determine a compression ratio based on the codebook and at least one of a vector quantization dimensionality, a group size, a codebook bit-width, or a scale group size.

At operation 806, the apparatus or system (e.g., the vector quantization engine 504, the computing system 1000, or at least one subsystem thereof) can be configured to quantize, via a vector quantization engine (e.g., the vector quantization engine 504), the group of weights of the pre-trained machine learning model a plurality of columns at a time according to the compression ratio to generate a quantized pre-trained model.

The process 800 can further include the apparatus or system (e.g., the vector quantization engine 504, the computing system 1000, or at least one subsystem thereof) being configured to perform one or more operations of: iteratively determining a respective layer from the pre-trained machine learning model; determining a respective compression ratio for each respective layer; and quantizing weights of each respective layer the plurality of columns at a time according to the respective compression ratio until all layers of the pre-trained machine learning model are quantized.

In some aspects, the apparatus or system (e.g., the vector quantization engine 504, the computing system 1000, or at least one subsystem thereof) can be configured to quantize the group of weights based on an inverse Hessian value. In some aspects, the plurality of columns can be equal to the vector quantization dimensionality.

In some aspects, the apparatus or system (e.g., the vector quantization engine 504, the computing system 1000, or at least one subsystem thereof) can be configured to update the quantized group of weights of the pre-trained machine learning model according to a weight update rule.

In some aspects, the apparatus or system (e.g., the vector quantization engine 504, the computing system 1000, or at least one subsystem thereof) can be configured to perform scale-group data normalization on the group of weights of the pre-trained machine learning model.

In some aspects, the apparatus or system (e.g., the vector quantization engine 504, the computing system 1000, or at least one subsystem thereof) can be configured to quantize the group of weights based on Hessian information associated with assigning a centroid associated with weights in the group.

In some aspects, the apparatus or system (e.g., the vector quantization engine 504, the computing system 1000, or at least one subsystem thereof) can be configured to update weights of uncompressed layers of the pre-trained machine learning model based on a determined error associated with the quantizing, via the vector quantization engine, of the group of weights.

In some aspects, the apparatus or system (e.g., the vector quantization engine 504, the computing system 1000, or at least one subsystem thereof) can be configured to quantize, via the vector quantization engine, the group of weights on a block-by-block basis.

In some aspects, each respective block includes a plurality of groups of weights corresponding to a plurality of codebooks. In some aspects, the vector quantization dimensionality can be associated with a number of groups included in a respective block.

In some aspects, the apparatus or system (e.g., the vector quantization engine 504, the computing system 1000, or at least one subsystem thereof) can be configured to scale the group of weights to generate scaled weights. In some aspects, the apparatus or system (e.g., the vector quantization engine 504, the computing system 1000, or at least one subsystem thereof) can be configured to scale the group of weights as part of the quantizing.

In some aspects, the apparatus or system (e.g., the vector quantization engine 504, the computing system 1000, or at least one subsystem thereof) can be configured to update unquantized weights of the pre-trained machine learning model.

In some aspects, the apparatus or system (e.g., the vector quantization engine 504, the computing system 1000, or at least one subsystem thereof) can be configured to quantize, via the vector quantization engine, the group of weights of the pre-trained machine learning model further by determining a centroid in the codebook associated with the plurality of columns that minimizes an output error to obtain a corresponding index.

In some aspects, the apparatus or system (e.g., the vector quantization engine 504, the computing system 1000, or at least one subsystem thereof) can be configured to determine the centroid in the codebook associated with the plurality of columns to obtain the corresponding index utilizing a sub-matrix of a Hessian matrix.

An apparatus for quantizing one or more machine learning models, the apparatus can include one or more of: means for obtaining a codebook for a group of weights of a pre-trained machine learning model; means for determining a compression ratio based on the codebook and at least one of a vector quantization dimensionality, a group size, a codebook bit-width, or a scale group size; and means for quantizing, via a vector quantization engine, the group of weights of the pre-trained machine learning model a plurality of columns at a time according to the compression ratio to generate a quantized pre-trained model.

In some aspects, a non-transitory computer-readable medium has stored thereon instructions that, when executed by one or more processors, cause the one or more processors to: obtain a codebook for a group of weights of a pre-trained machine learning model; determine a compression ratio based on the codebook and at least one of a vector quantization dimensionality, a group size, a codebook bit-width, or a scale group size; and quantize, via a vector quantization engine, the group of weights of the pre-trained machine learning model a plurality of columns at a time according to the compression ratio to generate a quantized pre-trained model.

FIG. 8B is a flowchart illustrating an example process 820 for quantizing or compressing a pre-trained model using one or more of the techniques described herein. In general, the apparatus or system (e.g., the vector quantization engine 504, the computing system 1000, or at least one subsystem thereof) can be configured to provide quantization of one or more machine-learning models (e.g., the pre-trained model 502 of FIG. 5A). In various aspects, the process 820 can be performed by one or more of the vector quantization engine 504, the computing system 1000, at least one processor 1010 of the computing system 1000, or a combination thereof.

At operation 822, an apparatus or system (e.g., the vector quantization engine 504, the computing system 1000, or at least one subsystem thereof) can be configured to arrange, via a vector quantization engine, data associated with a pre-trained model into a plurality of groups.

At operation 824, an apparatus or system (e.g., the vector quantization engine 504, the computing system 1000, or at least one subsystem thereof) can be configured to scale down data in each group of the plurality of groups to obtain first scaled data in the plurality of groups.

At operation 826, an apparatus or system (e.g., the vector quantization engine 504, the computing system 1000, or at least one subsystem thereof) can be configured to assign a respective codebook to a respective group of the plurality of groups.

At operation 828, an apparatus or system (e.g., the vector quantization engine 504, the computing system 1000, or at least one subsystem thereof) can be configured to, for a set of columns of data of a respective group of the plurality of groups obtained by a vector quantization dimensionality: scale up data in the set of columns to generate second scaled data of the set of columns; quantize, via the quantization engine, the second scaled data of the set of columns; identify an error associated with quantizing the second scaled data of the set of columns; and update, based on the error, data in remaining columns of the plurality of groups. In some aspects, the plurality of groups can be divided into a plurality of blocks.

In some aspects, the process 820 can further include, for a respective additional set of columns of the plurality of groups, the apparatus or system (e.g., the vector quantization engine 504, the computing system 1000, or at least one subsystem thereof) being configured to: scale up scaled data in the respective additional set of columns to generate respective additional scaled data of the respective additional set of columns; quantize, via the quantization engine, the respective additional scaled data of the respective additional set of columns; identify an error associated with quantizing the respective additional scaled data of the respective additional set of columns; and update, based on the error, respective remaining data in respective remaining columns of the plurality of groups.

In some aspects, the apparatus or system (e.g., the vector quantization engine 504, the computing system 1000, or at least one subsystem thereof) can be configured to quantize, via the quantization engine, the second scaled data of the set of columns by obtaining a respective centroid from the respective codebook for the set of columns of the plurality of groups.

In some aspects, the apparatus or system (e.g., the vector quantization engine 504, the computing system 1000, or at least one subsystem thereof) can be configured to quantize, via the quantization engine, the second scaled data of the set of columns by applying an inverse Hessian diagonal matrix to select a centroid from a codebook that minimizes an output error.

In some aspects, the apparatus or system (e.g., the vector quantization engine 504, the computing system 1000, or at least one subsystem thereof) can be configured to quantize, via the quantization engine, the second scaled data of the set of columns by applying an inverse Hessian diagonal matrix to select a vector from a codebook that best reconstructs an output of the pre-trained model.

In some aspects, an apparatus to compress a pre-trained model can include one or more: means for arranging, via a quantization engine, data associated with a pre-trained model into a plurality of groups; means for scaling down data in each group of the plurality of groups to obtain first scaled data in the plurality of groups; means for assigning a respective codebook to a respective group of the plurality of groups; and means for, for a set of columns of data of a respective group of the plurality of groups obtained by a vector quantization dimensionality: scaling up data in the set of columns to generate second scaled data of the set of columns; quantizing, via the quantization engine, the second scaled data of the set of columns; identifying an error associated with quantizing the second scaled data of the set of columns; and updating, based on the error, data in remaining columns of the plurality of groups.

In some aspects, a computer-readable storage device stores instructions which, when executed by at least one processor, causes the at least one processor: arrange, via a quantization engine, data associated with a pre-trained model into a plurality of groups; scale down data in each group of the plurality of groups to obtain first scaled data in the plurality of groups; assign a respective codebook to a respective group of the plurality of groups; and for a set of columns of data of a respective group of the plurality of groups obtained by a vector quantization dimensionality: scale up data in the set of columns to generate second scaled data of the set of columns; quantize, via the quantization engine, the second scaled data of the set of columns; identify an error associated with quantizing the second scaled data of the set of columns; and update, based on the error, data in remaining columns of the plurality of groups.

FIG. 8C is a flowchart illustrating an example process 840 for quantizing or compressing a pre-train model using one or more of the techniques described herein. In various aspects, the process 840 can be performed by one or more of the vector quantization engine 504, the computing system 1000, at least one processor 1010 of the computing system 1000, or a combination thereof.

At operation 842, an apparatus or system (e.g., the vector quantization engine 504, the computing system 1000, or at least one subsystem thereof) can be configured to receive, at a vector quantization engine, the pre-trained model.

At operation 844, an apparatus or system (e.g., the vector quantization engine 504, the computing system 1000, or at least one subsystem thereof) can be configured to scale data from a plurality of columns in a group of a plurality of groups, the data being associated with the pre-trained model to yield scaled data in the plurality of columns.

At operation 846, an apparatus or system (e.g., the vector quantization engine 504, the computing system 1000, or at least one subsystem thereof) can be configured to assign a codebook to the scaled data in the plurality of columns.

At operation 848, an apparatus or system (e.g., the vector quantization engine 504, the computing system 1000, or at least one subsystem thereof) can be configured to inverse scale the scaled data in the plurality of columns to obtain inverse scaled data.

At operation 850, an apparatus or system (e.g., the vector quantization engine 504, the computing system 1000, or at least one subsystem thereof) can be configured to quantize the inverse scaled data to obtain quantized data.

At operation 852, an apparatus or system (e.g., the vector quantization engine 504, the computing system 1000, or at least one subsystem thereof) can be configured to generate an error based on the quantized data.

At operation 854, an apparatus or system (e.g., the vector quantization engine 504, the computing system 1000, or at least one subsystem thereof) can be configured to update, based on the error, weights in the plurality of columns to obtain updated weights in the plurality of columns.

At operation 856, an apparatus or system (e.g., the vector quantization engine 504, the computing system 1000, or at least one subsystem thereof) can be configured to update weights, based on the error, in remaining columns in remaining groups from the plurality of groups.

In some aspects, an apparatus to compress a pre-trained model can include at least one memory and at least one processor coupled to the at least one memory and configured to: receive, at a vector quantization engine, the pre-trained model; scale data from a plurality of columns in a group of a plurality of groups, the data being associated with the pre-trained model to yield scaled data in the plurality of columns; assign a codebook to the scaled data in the plurality of columns; inverse scale the scaled data in the plurality of columns to obtain inverse scaled data; quantize the inverse scaled data to obtain quantized data; generate an error based on the quantized data; update, based on the error, weights in the plurality of columns to obtain updated weights in the plurality of columns; and update weights, based on the error, in remaining columns in remaining groups from the plurality of groups.

In some aspects, an apparatus to compress a pre-trained model, the apparatus can include one or more: means for receiving, at a vector quantization engine, the pre-trained model; means for scaling data from a plurality of columns in a group of a plurality of groups, the data being associated with the pre-trained model to yield scaled data in the plurality of columns; means for assigning a codebook to the scaled data in the plurality of columns; means for inverse scaling the scaled data in the plurality of columns to obtain inverse scaled data; means for quantizing the inverse scaled data to obtain quantized data; means for generating an error based on the quantized data; means for updating, based on the error, weights in the plurality of columns to obtain updated weights in the plurality of columns; and means for updating weights, based on the error, in remaining columns in remaining groups from the plurality of groups.

In some aspects, a non-transitory computer-readable medium having stored thereon instructions that, when executed by one or more processors, cause the one or more processors to: receive, at a vector quantization engine, the pre-trained model; scale data from a plurality of columns in a group of a plurality of groups, the data being associated with the pre-trained model to yield scaled data in the plurality of columns; assign a codebook to the scaled data in the plurality of columns; inverse scale the scaled data in the plurality of columns to obtain inverse scaled data; quantize the inverse scaled data to obtain quantized data; generate an error based on the quantized data; update, based on the error, weights in the plurality of columns to obtain updated weights in the plurality of columns; and update weights, based on the error, in remaining columns in remaining groups from the plurality of groups.

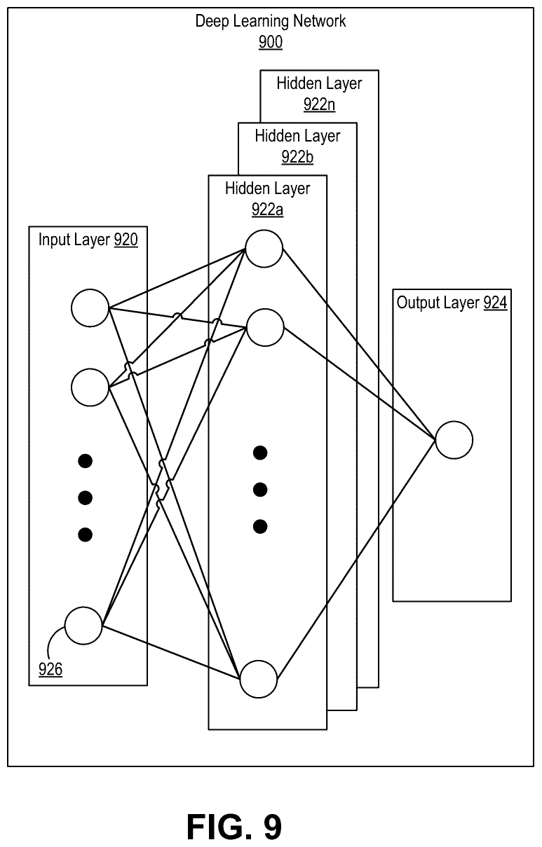

In some aspects, training of one or more of the machine learning models or systems (e.g., neural networks) described herein (e.g., such as the system 500 of FIG. 5, the deep neural network 900 of FIG. 9, among various other machine learning networks described herein) can be performed using online training (e.g., in some case on-device training), offline training, and/or various combinations of online and offline training. In some cases, online may refer to time periods during which the input data (e.g., such as the input data provided to the pre-trained model 502 of FIG. 5, etc.) is processed, for instance for performance of the quantizing implemented by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

As described herein, one or more of the machine learning models described herein may be implemented using a neural network or multiple neural networks. FIG. 9 is an illustrative example of a deep learning neural network 900 that can be used by the neural network 900 of FIG. 9. An input layer 920 includes input data. In one illustrative example, the input layer 920 can include data representing the pixels of an input video frame. The neural network 900 includes multiple hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The neural network 900 further includes an output layer 924 that provides an output resulting from the processing performed by the hidden layers 922a, 922b, through 922n. In one illustrative example, the output layer 924 can provide a classification for an object in an input video frame. The classification can include a class identifying the type of object (e.g., a person, a dog, a cat, or other object).

The neural network 900 is a multi-layer neural network of interconnected nodes. Each node can represent a piece of information. Information associated with the nodes is shared among the different layers and each layer retains information as information is processed. In some cases, the neural network 900 can include a feed-forward network, in which case there are no feedback connections where outputs of the network are fed back into itself. In some cases, the neural network 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the hidden layers 922a, 922b, through 922n can transform the information of each input node by applying activation functions to the information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 924, at which an output is provided. In some cases, while nodes (e.g., node 926) in the neural network 900 are shown as having multiple output lines, a node has a single output and all lines shown as being output from a node represent the same output value.

In some cases, each node or interconnection between nodes can have a weight that is a set of parameters derived from the training of the neural network 900. Once the neural network 900 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

The neural network 900 is pre-trained to process the features from the data in the input layer 920 using the different hidden layers 922a, 922b, through 922n in order to provide the output through the output layer 924. In an example in which the neural network 900 is used to identify objects in images, the neural network 900 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 900 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 900 is trained well enough so that the weights of the layers are accurately tuned.

For the example of identifying objects in images, the forward pass can include passing a training image through the neural network 900. The weights are initially randomized before the neural network 900 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 900, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 900 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 900 can perform a backward pass by determining which inputs (weights) most contributed to the loss of the network and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, w, denotes the initial weight, and n denotes a learning rate. The learning rate can be set to any suitable value, with a high learning rate including larger weight updates and a lower value indicating smaller weight updates.

In some cases, the neural network 900 can be trained using self-supervised learning.

The neural network 900 can include any suitable deep network. One example includes a convolutional neural network (CNN), which includes an input layer and an output layer, with multiple hidden layers between the input and out layers. An example of a CNN is described below with respect to FIG. 10. The hidden layers of a CNN include a series of convolutional, nonlinear, pooling (for downsampling), and fully connected layers. The neural network 900 can include any other deep network other than a CNN, such as an autoencoder, a deep belief nets (DBNs), a Recurrent Neural Networks (RNNs), among others.

FIG. 10 is a diagram illustrating an example of a system for implementing certain aspects of the present disclosure. In particular, FIG. 10 illustrates an example of computing system 1000, which can be for example any computing device making up a computing system, a camera system, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some examples, computing system 1000 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 1000 includes at least one processing unit (CPU or processor) 1010 and connection 1005 that couples various system components including system memory 1015, such as read-only memory (ROM) 1020 and random-access memory (RAM) 1025 to processor 1010. Computing system 1000 can include a cache 1012 of high-speed memory connected directly with, in close proximity to, or integrated as part of processor 1010.

Processor 1010 can include any general-purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1202.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some examples, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for quantizing one or more machine learning models, the apparatus comprising: at least one memory and at least one processor coupled to the at least one memory and configured to: obtain a codebook for a group of weights of a pre-trained machine learning model; determine a compression ratio based on the codebook and at least one of a vector quantization dimensionality, a group size, a codebook bit-width, or a scale group size; and quantize, via a vector quantization engine, the group of weights of the pre-trained machine learning model a plurality of columns at a time according to the compression ratio to generate a quantized pre-trained model.

Aspect 2. The apparatus of Aspect 1, wherein the at least one processor is configured to: iteratively determine a respective layer from the pre-trained machine learning model; determine a respective compression ratio for each respective layer; and quantize weights of each respective layer the plurality of columns at a time according to the respective compression ratio until all layers of the pre-trained machine learning model are quantized.

Aspect 3. The apparatus of any of Aspects 1-2, wherein the at least one processor is configured to quantize the group of weights based on an inverse Hessian value.

Aspect 4. The apparatus of any of Aspects 1-3, wherein the plurality of columns is equal to the vector quantization dimensionality.

Aspect 5. The apparatus of any of Aspects 1-4, wherein the at least one processor is configured to: update the quantized group of weights of the pre-trained machine learning model according to a weight update rule.

Aspect 6. The apparatus of any of Aspects 1-5, wherein the at least one processor is configured to: perform scale-group data normalization on the group of weights of the pre-trained machine learning model.

Aspect 7. The apparatus of any of Aspects 1-6, wherein the at least one processor is configured to: quantize the group of weights based on Hessian information associated with assigning a centroid associated with weights in the group.

Aspect 8. The apparatus of any of Aspects 1-7, wherein the at least one processor is configured to: update weights of uncompressed layers of the pre-trained machine learning model based on a determined error associated with the quantizing, via the vector quantization engine, of the group of weights.

Aspect 9. The apparatus of any of Aspects 1-8, wherein the at least one processor is configured to quantize, via the vector quantization engine, the group of weights on a block-by-block basis.

Aspect 10. The apparatus of any of Aspects 1-9, wherein each respective block comprises a plurality of groups of weights corresponding to a plurality of codebooks.

Aspect 11. The apparatus of any of Aspects 1-10, wherein the vector quantization dimensionality is associated with a number of groups included in a respective block.

Aspect 12. The apparatus of any of Aspects 1-11, wherein the at least one processor is configured to scale the group of weights to generate scaled weights.

Aspect 13. The apparatus of any of Aspects 1-12, wherein the at least one processor is configured to: scale the group of weights as part of the quantizing.

Aspect 14. The apparatus of any of Aspects 1-13, wherein the at least one processor is configured to: update unquantized weights of the pre-trained machine learning model.

Aspect 15. The apparatus of any of Aspects 1-14, wherein the at least one processor is configured to quantize, via the vector quantization engine, the group of weights of the pre-trained machine learning model further by determining a centroid in the codebook associated with the plurality of columns that minimizes an output error to obtain a corresponding index.

Aspect 16. The apparatus of any of Aspects 1-15, wherein the at least one processor is configured to determine the centroid in the codebook associated with the plurality of columns to obtain the corresponding index utilizing a sub-matrix of a Hessian matrix.

Aspect 17. A method for quantizing one or more machine learning models, the method comprising: obtaining a codebook for a group of weights of a pre-trained machine learning model; determining a compression ratio based on the codebook and at least one of a vector quantization dimensionality, a group size, a codebook bit-width, or a scale group size; and quantizing, via a vector quantization engine, the group of weights of the pre-trained machine learning model a plurality of columns at a time according to the compression ratio to generate a quantized pre-trained model.

Aspect 18. The method of Aspect 17, further comprising iteratively determining a respective layer from the pre-trained machine learning model; determining a respective compression ratio for each respective layer; and quantizing weights of each respective layer the plurality of columns at a time according to the respective compression ratio until all layers of the pre-trained machine learning model are quantized.

Aspect 19. The method of any of Aspects 17-18, wherein the at least one processor is configured to quantize the group of weights based on an inverse Hessian value.

Aspect 20. The method of any of Aspects 17-19, wherein the plurality of columns is equal to the vector quantization dimensionality.

Aspect 21. The method of any of Aspects 17-20, wherein the at least one processor is configured to: update the quantized group of weights of the pre-trained machine learning model according to a weight update rule.

Aspect 22. The method of any of Aspects 17-21, wherein the at least one processor is configured to: perform scale-group data normalization on the group of weights of the pre-trained machine learning model.

Aspect 23. The method of any of Aspects 17-22, wherein the at least one processor is configured to: quantize the group of weights based on Hessian information associated with assigning a centroid associated with weights in the group.

Aspect 24. The method of any of Aspects 17-23, wherein the at least one processor is configured to: update weights of uncompressed layers of the pre-trained machine learning model based on a determined error associated with the quantizing, via the vector quantization engine, of the group of weights.

Aspect 25. The method of any of Aspects 17-24, wherein the at least one processor is configured to quantize, via the vector quantization engine, the group of weights on a block-by-block basis.

Aspect 26. The method of any of Aspects 17-25, wherein each respective block comprises a plurality of groups of weights corresponding to a plurality of codebooks.

Aspect 27. The method of any of Aspects 17-26, wherein the vector quantization dimensionality is associated with a number of groups included in a respective block.

Aspect 28. The method of any of Aspects 17-27, wherein the at least one processor is configured to scale the group of weights to generate scaled weights.

Aspect 29. The method of any of Aspects 17-28, wherein the at least one processor is configured to: scale the group of weights as part of the quantizing.

Aspect 30. The method of any of Aspects 17-29, wherein the at least one processor is configured to: update unquantized weights of the pre-trained machine learning model.

Aspect 31 The method of any of Aspects 17-30, wherein the at least one processor is configured to quantize, via the vector quantization engine, the group of weights of the pre-trained machine learning model further by determining a centroid in the codebook associated with the plurality of columns that minimizes an output error to obtain a corresponding index.

Aspect 32. The method of any of Aspects 17-31, wherein the at least one processor is configured to determine the centroid in the codebook associated with the plurality of columns to obtain the corresponding index utilizing a sub-matrix of a Hessian matrix.

Aspect 33. An apparatus for quantizing one or more machine learning models, the apparatus comprising: means for obtaining a codebook for a group of weights of a pre-trained machine learning model; means for determining a compression ratio based on the codebook and at least one of a vector quantization dimensionality, a group size, a codebook bit-width, or a scale group size; and means for quantizing, via a vector quantization engine, the group of weights of the pre-trained machine learning model a plurality of columns at a time according to the compression ratio to generate a quantized pre-trained model.

Aspect 34. A non-transitory computer-readable medium having stored thereon instructions that, when executed by one or more processors, cause the one or more processors to: obtain a codebook for a group of weights of a pre-trained machine learning model; determine a compression ratio based on the codebook and at least one of a vector quantization dimensionality, a group size, a codebook bit-width, or a scale group size; and quantize, via a vector quantization engine, the group of weights of the pre-trained machine learning model a plurality of columns at a time according to the compression ratio to generate a quantized pre-trained model.

Aspect 35. An apparatus to compress a pre-trained model, the apparatus comprising: at least one memory and at least one processor coupled to the at least one memory and configured to: arrange, via a quantization engine, data associated with a pre-trained model into a plurality of groups; scale down data in each group of the plurality of groups to obtain first scaled data in the plurality of groups; assign a respective codebook to a respective group of the plurality of groups; and for a set of columns of data of a respective group of the plurality of groups obtained by a vector quantization dimensionality: scale up data in the set of columns to generate second scaled data of the set of columns; quantize, via the quantization engine, the second scaled data of the set of columns; identify an error associated with quantizing the second scaled data of the set of columns; and update, based on the error, data in remaining columns of the plurality of groups.

Aspect 36. The apparatus of Aspect 36, wherein the plurality of groups is divided into a plurality of blocks.

Aspect 37. The apparatus of any of Aspects 35-36, wherein the at least one processor is configured to: for a respective additional set of columns of the plurality of groups: scale up scaled data in the respective additional set of columns to generate respective additional scaled data of the respective additional set of columns; quantize, via the quantization engine, the respective additional scaled data of the respective additional set of columns; identify an error associated with quantizing the respective additional scaled data of the respective additional set of columns; and update, based on the error, respective remaining data in respective remaining columns of the plurality of groups.

Aspect 38. The apparatus of any of Aspects 35-37, wherein the at least one processor is configured to quantize, via the quantization engine, the second scaled data of the set of columns by obtaining a respective centroid from the respective codebook for the set of columns of the plurality of groups. 39 The apparatus of claim 36, wherein the at least one processor is configured to quantize, via the quantization engine, the second scaled data of the set of columns by applying an inverse Hessian diagonal matrix to select a centroid from a codebook that minimizes an output error.

Aspect 40. The apparatus of any of Aspects 35-38, wherein the at least one processor is configured to quantize, via the quantization engine, the second scaled data of the set of columns by applying an inverse Hessian diagonal matrix to select a vector from a codebook that best reconstructs an output of the pre-trained model.

Aspect 41. A method to compress a pre-trained model, the method comprising: arranging, via a quantization engine, data associated with a pre-trained model into a plurality of groups; scaling down data in each group of the plurality of groups to obtain first scaled data in the plurality of groups; assigning a respective codebook to a respective group of the plurality of groups; and for a set of columns of data of a respective group of the plurality of groups obtained by a vector quantization dimensionality: scaling up data in the set of columns to generate second scaled data of the set of columns; quantizing, via the quantization engine, the second scaled data of the set of columns; identifying an error associated with quantizing the second scaled data of the set of columns; and updating, based on the error, data in remaining columns of the plurality of groups.

Aspect 42. The method of Aspect 41, wherein the plurality of groups is divided into a plurality of blocks.

Aspect 43. The method of any of Aspects 41-42, further comprising: for a respective additional set of columns of the plurality of groups: scaling up scaled data in the respective additional set of columns to generate respective additional scaled data of the respective additional set of columns; quantizing, via the quantization engine, the respective additional scaled data of the respective additional set of columns; identifying an error associated with quantizing the respective additional scaled data of the respective additional set of columns; and updating, based on the error, respective remaining data in respective remaining columns of the plurality of groups.

Aspect 44. The method of any of Aspects 41-43, wherein the at least one processor is configured to quantize, via the quantization engine, the second scaled data of the set of columns by obtaining a respective centroid from the respective codebook for the set of columns of the plurality of groups. 45 The method of claim 41, wherein the at least one processor is configured to quantize, via the quantization engine, the second scaled data of the set of columns by applying an inverse Hessian diagonal matrix to select a centroid from a codebook that minimizes an output error.

Aspect 46. The method of any of Aspects 41-44, wherein the at least one processor is configured to quantize, via the quantization engine, the second scaled data of the set of columns by applying an inverse Hessian diagonal matrix to select a vector from a codebook that best reconstructs an output of the pre-trained model.

Aspect 47. An apparatus to compress a pre-trained model, the apparatus comprising: means for arranging, via a quantization engine, data associated with a pre-trained model into a plurality of groups; means for scaling down data in each group of the plurality of groups to obtain first scaled data in the plurality of groups; means for assigning a respective codebook to a respective group of the plurality of groups; and means for, for a set of columns of data of a respective group of the plurality of groups obtained by a vector quantization dimensionality: scaling up data in the set of columns to generate second scaled data of the set of columns; quantizing, via the quantization engine, the second scaled data of the set of columns; identifying an error associated with quantizing the second scaled data of the set of columns; and updating, based on the error, data in remaining columns of the plurality of groups.

Aspect 48. A non-transitory computer-readable medium having stored thereon instructions that, when executed by one or more processors, cause the one or more processors to: arrange, via a quantization engine, data associated with a pre-trained model into a plurality of groups; scale down data in each group of the plurality of groups to obtain first scaled data in the plurality of groups; assign a respective codebook to a respective group of the plurality of groups; and for a set of columns of data of a respective group of the plurality of groups obtained by a vector quantization dimensionality: scale up data in the set of columns to generate second scaled data of the set of columns; quantize, via the quantization engine, the second scaled data of the set of columns; identify an error associated with quantizing the second scaled data of the set of columns; and update, based on the error, data in remaining columns of the plurality of groups.

Aspect 49. An apparatus to compress a pre-trained model, the apparatus comprising: at least one memory and at least one processor coupled to the at least one memory and configured to: receive, at a vector quantization engine, the pre-trained model; scale data from a plurality of columns in a group of a plurality of groups, the data being associated with the pre-trained model to yield scaled data in the plurality of columns; assign a codebook to the scaled data in the plurality of columns; inverse scale the scaled data in the plurality of columns to obtain inverse scaled data; quantize the inverse scaled data to obtain quantized data; generate an error based on the quantized data; update, based on the error, weights in the plurality of columns to obtain updated weights in the plurality of columns; and update weights, based on the error, in remaining columns in remaining groups from the plurality of groups.

Aspect 49. An apparatus to compress a pre-trained model, the apparatus comprising: at least one memory and at least one processor coupled to the at least one memory and configured to: receive, at a vector quantization engine, the pre-trained model; scale data from a plurality of columns in a group of a plurality of groups, the data being associated with the pre-trained model to yield scaled data in the plurality of columns; assign a codebook to the scaled data in the plurality of columns; inverse scale the scaled data in the plurality of columns to obtain inverse scaled data; quantize the inverse scaled data to obtain quantized data; generate an error based on the quantized data; update, based on the error, weights in the plurality of columns to obtain updated weights in the plurality of columns; and update weights, based on the error, in remaining columns in remaining groups from the plurality of groups.

Aspect 50. A method to compress a pre-trained model, the method comprising: receiving, at a vector quantization engine, the pre-trained model; scaling data from a plurality of columns in a group of a plurality of groups, the data being associated with the pre-trained model to yield scaled data in the plurality of columns; assigning a codebook to the scaled data in the plurality of columns; inverse scaling the scaled data in the plurality of columns to obtain inverse scaled data; quantizing the inverse scaled data to obtain quantized data; generating an error based on the quantized data; updating, based on the error, weights in the plurality of columns to obtain updated weights in the plurality of columns; and updating weights, based on the error, in remaining columns in remaining groups from the plurality of groups.

Aspect 51. A non-transitory computer-readable medium having stored thereon instructions that, when executed by one or more processors, cause the one or more processors to: receive, at a vector quantization engine, the pre-trained model; scale data from a plurality of columns in a group of a plurality of groups, the data being associated with the pre-trained model to yield scaled data in the plurality of columns; assign a codebook to the scaled data in the plurality of columns; inverse scale the scaled data in the plurality of columns to obtain inverse scaled data; quantize the inverse scaled data to obtain quantized data; generate an error based on the quantized data; update, based on the error, weights in the plurality of columns to obtain updated weights in the plurality of columns; and update weights, based on the error, in remaining columns in remaining groups from the plurality of groups.

What is claimed is:

1. An apparatus for quantizing one or more machine learning models, the apparatus comprising:
at least one memory; and
at least one processor coupled to the at least one memory and configured to:
obtain a codebook for a group of weights of a pre-trained machine learning model;
determine a compression ratio based on the codebook and at least one of a vector quantization dimensionality, a group size, a codebook bit-width, or a scale group size; and
quantize, via a vector quantization engine, the group of weights of the pre-trained machine learning model a plurality of columns at a time according to the compression ratio to generate a quantized pre-trained model.

2. The apparatus of claim 1, wherein the at least one processor is configured to:
iteratively determine a respective layer from the pre-trained machine learning model;
determine a respective compression ratio for each respective layer; and
quantize weights of each respective layer the plurality of columns at a time according to the respective compression ratio until all layers of the pre-trained machine learning model are quantized.

3. The apparatus of claim 1, wherein the at least one processor is configured to quantize the group of weights based on an inverse Hessian value.

4. The apparatus of claim 1, wherein the plurality of columns is equal to the vector quantization dimensionality.

5. The apparatus of claim 1, wherein the at least one processor is configured to:
update the quantized group of weights of the pre-trained machine learning model according to a weight update rule.

6. The apparatus of claim 1, wherein the at least one processor is configured to:
perform scale-group data normalization on the group of weights of the pre-trained machine learning model.

7. The apparatus of claim 1, wherein the at least one processor is configured to:
quantize the group of weights based on Hessian information associated with assigning a centroid associated with weights in the group.

8. The apparatus of claim 1, wherein the at least one processor is configured to:
update weights of uncompressed layers of the pre-trained machine learning model based on a determined error associated with the quantizing, via the vector quantization engine, of the group of weights.

9. The apparatus of claim 1, wherein the at least one processor is configured to quantize, via the vector quantization engine, the group of weights on a block-by-block basis.

10. The apparatus of claim 9, wherein each respective block comprises a plurality of groups of weights corresponding to a plurality of codebooks.

11. The apparatus of claim 9, wherein the vector quantization dimensionality is associated with a number of groups included in a respective block.

12. The apparatus of claim 1, wherein the at least one processor is configured to scale the group of weights to generate scaled weights.

13. The apparatus of claim 12, wherein the at least one processor is configured to:
scale the group of weights as part of the quantizing.

14. The apparatus of claim 1, wherein the at least one processor is configured to:
update unquantized weights of the pre-trained machine learning model.

15. The apparatus of claim 1, wherein the at least one processor is configured to quantize, via the vector quantization engine, the group of weights of the pre-trained machine learning model further by determining a centroid in the codebook associated with the plurality of columns that minimizes an output error to obtain a corresponding index.

16. The apparatus of claim 15, wherein the at least one processor is configured to determine the centroid in the codebook associated with the plurality of columns to obtain the corresponding index utilizing a sub-matrix of a Hessian matrix.

17. A method for quantizing one or more machine learning models, the method comprising:
obtaining a codebook for a group of weights of a pre-trained machine learning model;
determining a compression ratio based on the codebook and at least one of a vector quantization dimensionality, a group size, a codebook bit-width, or a scale group size; and
quantizing, via a vector quantization engine, the group of weights of the pre-trained machine learning model a plurality of columns at a time according to the compression ratio to generate a quantized pre-trained model.

18. The method of claim 17, further comprising:
iteratively determining a respective layer from the pre-trained machine learning model;
determining a respective compression ratio for each respective layer; and
quantizing weights of each respective layer the plurality of columns at a time according to the respective compression ratio until all layers of the pre-trained machine learning model are quantized.

19. The method of claim 17, further comprising quantizing the group of weights based on an inverse Hessian value.

20. A non-transitory computer-readable medium having stored thereon instructions that, when executed by one or more processors, cause the one or more processors to:
obtain a codebook for a group of weights of a pre-trained machine learning model;
determine a compression ratio based on the codebook and at least one of a vector quantization dimensionality, a group size, a codebook bit-width, or a scale group size; and
quantize, via a vector quantization engine, the group of weights of the pre-trained machine learning model a plurality of columns at a time according to the compression ratio to generate a quantized pre-trained model.
